(19) United States
(12) Patent Application Publication
(10) Pub. No.: US 2002/0004351 A1
(43) Pub. Date: Jan. 10, 2002

(54) PACKAGING PRODUCT

(76) Inventors: WAZIR NOBBEE, CHESTERFIELD, VA (US); ROBERT B. LAGOOD, WILMINGTON, DE (US); MICHAEL H. SCHOLLA, AVONDALE, PA (US); DAVID JACKSON MCGINTY, MIDLOTHIAN, VA (US)

Correspondence Address: THOMAS W GORMAN, E I DU PONT DE NEMOURS AND COMPANY, LEGAL - PATENTS, 1007 MARKET STREET, WILMINGTON, DE, 19898

(21) Appl. No.: 09/187,898

(22) Filed: Nov. 6, 1998

Related U.S. Application Data
(63) Continuation-in-part of application No. 09/035,143, filed on Mar. 5, 1998, now Pat. No. 6,010,970.
Application No. 09/035,143 is a continuation-in-part of application No. 08/811,645, filed on Mar. 5, 1997, now abandoned.

(51) Int. Cl. B32B 1/00; D04H 1/00; D04H 3/00; D04H 5/00; D04H 13/00; B32B 27/12; D04H 3/16

(52) U.S. Cl. 442/394; 442/401; 428/219

(57) ABSTRACT

A gas permeable package is provided that is comprised of a bonded, gas permeable, fibrous sheet material consisting of continuous lengths of bonded plexifilamentary fibril strands of a polyolefin polymer and a pigment. The polyolefin comprises at least 90% by weight of the fibril strands and the pigment comprises between 0.05% and 10% by weight of the fibril strands. The polyolefin polymer is preferably selected from the group of polyethylene, polypropylene, and copolymers comprised primarily of ethylene and propylene units, and is more preferably polyethylene. The pigment is preferably titanium dioxide. The fibrous sheet material has a basis weight of less than 85 g/m², a delamination strength of at least 60 N/m, and an opacity of at least 90% if the sheet has a delamination strength less than 120 N/m, an opacity of at least 85% if the sheet has a delamination strength between 120 N/m and 150 N/m, and an opacity of at least 80% if the sheet has a delamination strength greater than 150 N/m.

This application is a continuation-in-part of U.S. patent application Ser. No. 09/035,143 (now pending) filed on Mar. 5, 1998, which is a continuation-in-part of U.S. patent application Ser. No. 08/811,645 (now pending) filed on Mar. 5, 1997.

### FIELD OF THE INVENTION

This invention relates to packaging that incorporates a gas permeable polymeric sheet of plexifilamentary film-fibril strands. More particularly, the invention relates to such packaging and a process for forming and sealing such packaging wherein the packaging is improved by adding small amounts of pigment to the sheet of polymeric plexifilamentary film-fibril strands used in the packaging.

### BACKGROUND OF THE INVENTION

Certain products must shipped and sold in packaging that is permeable to air. For example, if a package is one that may be shipped by airplane, it is beneficial if the package can breath so that the package is able to adjust to changing air pressures during travel. Likewise, pouches holding moisture-absorbing desiccants, that are placed inside many packages, must have very small holes that permit the passage of moisture and air but that hold fine desiccant particles inside the package. Similarly, packages holding medical instruments and other devices that are sterilized by gas sterilization processes must be permeable to sterilization gases.

In a gas sterilization process, an item being sterilized is placed in a sterilization gas, such as ethylene oxide, that kills bacteria and other microorganisms. Once sterilized, contamination of the item is prevented by keeping the item sealed in a package that blocks the passage of bacteria and other microorganisms. One type of package product that works well in a gas sterilization process is a package with very fine pores that permit the entry of a sterilization gas, but block the passage of bacteria that might contaminate the packaged item after sterilization is complete. With such a package, an item that needs to be sterilized can be sealed in the package and then the whole package can be placed in the sterilizing gas. The sterilizing gas is forced under pressure into the package through the small pores in the package. After sufficient time has passed to assure that all bacteria inside the package have been killed, the sterilizing gas is evacuated and pressurized room air is forced back into the package through the pores. The small size of the pores prevents bacteria from getting back into the package and contaminating the sterilized item.

One common type of sterile package is shown in FIG. 1. The package includes a tray 42 of a size designed to accommodate a medical device 48. The tray 42 is preferably made of a rigid plastic such as glycol modified polyethylene terephthalate (“PETG”), polyvinyl chloride (“PVC”), high impact polystyrene (“HIPS”), or polypropylene (“PP”). The tray 42 is covered with a sheet 44 made of a gas permeable sheet material that blocks the passage of bacteria. Sheet 44 is normally sealed to the tray 42 by means of an adhesive 46. The adhesive 46 is commonly coated on the sheet 44, but may alternatively be applied to the edges of the tray 42. When the adhesive is coated on the sheet 44, the adhesive is laid down in a manner that minimizes the reduction of the sheet's permeability to gases. The sheet 44 and tray 42 are sealed together by applying heat and pressure to the adhesive 46 through the sheet 44.

Another common sterile package is the sterile pouch 50 shown in FIGS. 2 and 3. The pouch 50 is formed of a gas impermeable film 54, commonly made of polyester, to which a gas permeable sheet 52 is sealed. The film 54 and the gas permeable sheet 52 are joined together by an adhesive 56. The adhesive 56 may be coated on the sheet 52 or the film 54. If the adhesive 56 is coated on the sheet 52, the adhesive should be deposited in a manner that minimizes the reduction of the permeability of the sheet to gases. Preferably, an adhesive bond is formed between the sheet 52 and film 54 by means of a thermoplastic adhesive 56, which melts at a lower temperature than either the sheet 52 or the film 54. The thermoplastic adhesive is melted by applying heat and pressure to the adhesive through the film 54 and/or the sheet 52. Another common sterile package (not shown) that is a variant of the pouch of FIGS. 2 and 3 is known as a form-fill-seal package (not shown). In a form-fill-seal package, a film layer like the film 54 of the pouch of FIGS. 2 and 3 is first stretched under pressure to form a concave pocket into which an item can be placed before a gas permeable sheet with a thermoplastic coating is applied over the film.

Still another common package, which is a variant of the pouch of FIGS. 2 and 3, is known as a header or breather bag. In the header or breather bag, the pouch is formed from two layers of an impermeable film similar to the film 54. These films are commonly made of polyolefins, but may also be made of polyester or other synthetic materials. A section of the impermeable film is perforated or removed, and a gas permeable sheet material is sealed over the opening so as to act as a vent. The film and the gas permeable sheet material are joined together by an adhesive that is preferably a thermoplastic adhesive. The adhesive is applied in a manner that minimizes reduction in the permeability of the gas permeable sheet material.

The adhesives used for sealing the packages described above are commonly thermally activated adhesives such as ethylene vinyl acetate. The melting temperature of the preferred adhesives are less than that of the polymers of the preferred films (e.g., a melting point of about 177° C. for polyester film) and less than that of the polyethylene of the preferred gas permeable sheets (m.p. of about 134° C.). Alternatively, other adhesives such as low density polyethylene may be used. According to another alternative, the tray 42 or the film 54 may be made of a thermoplastic that fuses with the gas permeable sheet when heated.

The peel strength of the package seal that will be opened to remove an item from the package should be great enough to maintain a dependable seal. When the package seal is opened to remove a sterilized item, the film and the microporous sheet should not tear or delaminate because tearing generates particulates that could contaminate the sterile item. In order to prevent delamination, the materials from which the package is formed must have delamination strengths that are greater than the peel strength of the seal that is broken to open the package. In addition, the package is constructed in a manner that allows the sterilized item to be removed from the package without the item contacting any non-sterile portions of the package such as the unsterilized outside areas of the package.

TYVEK® spunbonded olefin has been in use for a number of years as a gas permeable, bacteria impermeable sheet material for packaging applications, including envelopes, desiccant pouches, and sterile packages. E. I. du Pont de Nemours and Company (DuPont) makes and sells TYVEK® spunbonded sheet material. TYVEK® is a registered trademark owned by DuPont. TYVEK® nonwoven sheet material has been a good choice for packaging applications because of its excellent strength properties, its good microbial barrier properties, its reasonable air permeability, its resistance to tearing, its light weight, its printability, and its single layer structure that gives rise to a low manufacturing cost relative to most competitive materials. The use of TYVEK® spunbonded olefin sheet material in sterile packaging is disclosed in U.S. Pat. No. 4,554,207 to Lee (assigned to DuPont). TYVEK® spunbonded sheet material is made of flash-spun plexifilamentary film-fibril polyethylene strands that have been thermally bonded into sheet form.

The art of flash-spinning plexifilamentary film-fibrils from a polymer in a solution or a dispersion is known in the art. The term “plexifilamentary” means a three-dimensional integral network of a multitude of thin, ribbon-like, film-fibril elements of random length and with a mean thickness of less than about 4 microns and with a median fibril width of less than about 25 microns. In plexifilamentary structures, the film-fibril elements are generally coextensively aligned with the longitudinal axis of the structure and they intermittently unite and separate at irregular intervals in various places throughout the length, width and thickness of the structure to form the three-dimensional network.

The process of forming plexifilamentary film-fibril strands and forming the same into non-woven sheet material has been disclosed and extensively discussed in U.S. Pat. No. 3,081,519 to Blades et al.; U.S. Pat. No. 3,227,794 to Anderson et al.; U.S. Pat. No. 3,169,899 to Steuber; U.S. Pat. No. 3,860,369 to Brethauer et al.; and U.S. Pat. No. 5,603,885 to McGinty (all of which are assigned to DuPont). This process and various improvements thereof have been practiced by DuPont for a number of years in the manufacture its TYVEK® spunbonded olefin.

A flash-spinning apparatus is shown in FIG. 4 that is similar to that disclosed in U.S. Pat. No. 3,860,369 to Brethauer et al., which is hereby incorporated by reference. According to the flash-spinning process, a mixture of polymer and spin agent is provided through a pressurized supply conduit 13 to a spinning orifice 14. The polymer mixture in chamber 16 is discharged through a spin orifice 14 where extensional flow near the approach of the orifice helps to orient the polymer into elongated polymer molecules. When polymer and spin agent discharge from the orifice, the spin agent rapidly expands as a gas and leaves behind fibrillated plexifilamentary film-fibrils. The spin agent's expansion during flashing accelerates the polymer so as to further stretch the polymer molecules just as the film-fibrils are being formed and the polymer is being cooled by the adiabatic expansion. The quenching of the polymer freezes the linear orientation of the polymer molecule chains in place, which contributes to the strength of the resulting flash-spun plexifilamentary polymer structure.

The polymer strand 20 discharged from the spin orifice 14 is directed against a rotating lobed deflector baffle 26 that spreads the strand 20 into a more planar web structure 24, and alternately directs the web to the left and right as the web descends to a moving collection belt 32. The web forms a fibrous batt 34 that is passed under a roller 31 that compresses the batt into a sheet 35 formed with plexifilamentary film-fibril networks oriented in an overlapping multi-directional configuration. The sheet 35 exits the spin chamber 10 through the outlet 12 before being collected on a sheet collection roll 29. The sheet 35 may be thermally bonded in order to obtain desired sheet strength, opacity, moisture permeability and air permeability.

The polymers that have been conventionally used in production of flash-spun plexifilamentary sheets are polyolefins, especially polyethylene. The term “polyethylene” is intended to embrace not only homopolymers of ethylene but also copolymers wherein at least 85% of the recurring units are ethylene units. A preferred polyethylene polymer is a homopolymeric linear polyethylene which has an upper limit of melting range of about 130° to 135° C., a density in the range of 0.94 to 0.98 g/cm3 and a melt index (as defined by ASTM D-1238-57T, Condition B) of 0.1 to 6.0. Polypropylene is another polyolefin that can be used to make sheet material for use in packaging applications requiring higher temperature sterilization processes such as steam sterilization.

British Patent Specification 891,943 (assigned to DuPont) discloses that additives, including colored pigments, can be added to the polymeric material used in producing flash-spun plexifilamentary fibers. U.S. Pat. No. 3,169,899 (assigned to DuPont) suggests that flash-spun polymer with various additives, including pigments, may be used in producing plexifilamentary sheet material. However, this prior art does not disclose or suggest how pigments might be used to produce sheet material with improved physical properties, what the properties of such sheet material might be, or how such sheet material might be used in making packaging.

The gas permeable sheet material used in sterile packaging must ordinarily retain an opaque appearance. If the sheet material becomes transparent during bonding of the sheet material or during sealing of the package into which the sheet material is incorporated, a number of problems arise. First, matter printed on the package, such as bar codes or product information, becomes very difficult to read as the sheet material becomes more transparent. Second, reduced opacity gives spunbonded sheets a flimsy and mottled appearance that leads consumers to question the package's ability to keep out bacteria even if the barrier properties have not been compromised. Third, reduced opacity may also cause quicker degradation of sheet strength in the presence of ultraviolet light, such as sunlight, because more light passes through a less opaque sheet. Finally, it is often desirable that a packaged item not be visible outside of the package.

Unfortunately, it is difficult to maintain good sheet opacity in a spunbonded sheet with high tear and delamination strengths, and it is also difficult to maintain good opacity in spunbonded sheets used in packages that are thermally sealed at high speed. It has been found that the delamination strength of a flash-spun polyethylene sheet of a given basis weight can be significantly increased by increasing the amount of thermal bonding to which the sheet is subjected. However, the opacity of flash-spun plexifilamentary sheets decreases with increased amounts of thermal bonding. The tradeoff between delamination strength and sheet appearance has been troublesome in packaging products where a transparent or mottled appearance is undesirable. In the past, sheets with basis weights higher than what is needed for strength and bacterial barrier properties have been used in sterile packaging in order to permit a high level of thermal bonding while maintaining a desired level of opacity.

In packages like those shown in FIGS. 1-3 and in form-fill-seal packages (not shown), the sheet of gas permeable sheet material is attached to the tray 42 (FIG. 1) or to the impermeable plastic film 54 (FIG. 3) by means of an adhesive. The adhesive is normally coated on the gas permeable sheet or the film material, and is of a type that does not become sticky until heat is applied to the adhesive. The most useful adhesives for application to the gas permeable sheet are adhesives that can be coated on the porous sheet in a manner that does not substantially reduce the gas permeability of the sheet, as for example by light spray coating processes. The process by which these packages are sealed is known in the art and briefly discussed below.

In the process for sealing tray packages like that shown in FIG. 1, the trays are generally first molded from one of the rigid hard plastics discussed above, such as PETG, HIPS, or PP. In either a continuous operation, or in a completely separate step, the formed trays are placed on a moving line in a manner such that the trays hang in an openings on the line and the flat edges 43 of the trays rest on a flat surface. The item being packaged is placed into the trays and the trays are covered with the gas permeable sheet material that will form the tray lids. The gas permeable sheet material is generally one that has been coated with a thermoplastic adhesive on the side facing the tray. The opposite side of the sheet facing away from the tray may already be printed with written or graphic information. Once the sheet material is in place, a heated surface is pressed down on top of the gas permeable sheet over the portions where a seal is to be formed. The sheet material between the adjoining packages is generally cut after the seals have been formed, but may alternatively be cut as the packages are sealed.

In the process for forming and sealing a pouch like that shown in FIGS. 2 and 3, the film 54 is covered with the gas permeable sheet material 52 and run through a sealing machine. Generally, either the film 54 or the gas permeable sheet material 52 is pre-coated with a thermoplastic adhesive. The side of the sheet material 52 facing away from the film may already be printed with written or graphic information or the sheet may be printed in conjunction with the sealing process. Once the sheet material is in place, heat is normally applied through the film by pressing a heated surface against the film over what will be the bottom edge and side edges of each pouch. Alternatively, the sealing heat may be applied through the gas permeable sheet. The film and sheet material between adjoining pouches are generally cut after the seals have been formed, but may alternatively be cut as the pouches are being sealed. With pouch packages, the item to be enclosed in the pouch is normally inserted into the pouch through the top edge that has not been sealed. The open edge is then sealed by applying heat under pressure through the gas permeable sheet and/or the film.

In the process for forming and sealing a form-fill-seal package (not shown), sections of a moldable film are vacuum or plug molded to form concave indentations in the film. The film can be a multi-layer structure made with an ethylene vinyl acetate (“EVAc”) coating. A formable plastic material commonly used as the moldable film in a nylon film with an adhesive layer or an EVAc/SURLYN® ionomer/EVAc film, as for example a U-film sold by Rexam Corporation of Madison, Wis. The item being packaged is placed into the indentation in the film and then covered with a gas permeable sheet material. The thermoplastic adhesive layer may be coated onto the formable plastic film layer by extrusion coating, lamination, or coextrusion processes. If the film is one that does not have an adhesive coating, the gas permeable sheet material will generally be coated with a thermoplastic adhesive on the side facing the tray. The opposite side of the sheet facing away from the formed film may already be printed with written or graphic information. Once the sheet material is in place, a heated surface is pressed down on top of the gas permeable sheet over the portions of the film that have not been molded. The sheet material between packages is generally cut after the seals have been formed, but may alternatively be cut as the packages are being sealed.

In each of the package formation processes described above, heat is normally applied to the gas permeable sheet material when generating the package seal. Applying the heat under pressure increases the amount of heat transferred to the sheet and to the adhesive. Heating of the adhesive is a function of the temperature of the heating element (normally a heated bar or roll) applied to the package sheet, the pressure at which the heating element is applied, and the duration of the heat application. Heating of the adhesive is also dependent on the basis weight of the porous sheet that the heat must pass through in order to reach the adhesive. It is normally desirable to heat the adhesive as quickly as possible in order to increase the production rate for making and/or sealing the packages. However, quicker heating of the adhesive requires the application of higher temperatures and pressures to the porous sheet material. The application of a sufficient degree of heat and pressure to activate the adhesive at high production or sealing rates also reduces the opacity of a spunbonded gas permeable sheet material, such as conventional TYVEK® spunbonded sheet material. This reduction in opacity is especially troublesome when the spunbonded sheet material being sealed is of a low basis weight.

Accordingly, there is a need for package made with a spunbonded, gas permeable, bacteria impermeable, sheet material that can be subjected to substantial thermal bonding and/or sealing without undergoing a significant reduction in the opacity of the sheet. There is also a need for a sterile package that is made with a porous spunbonded sheet material that when printed is highly readable, even by bar code scanning equipment.

### SUMMARY OF THE INVENTION

There is provided by the present invention a bonded, gas permeable, fibrous sheet material consisting of continuous lengths of bonded plexifilamentary fibril strands of a polyolefin polymer and a pigment wherein the polyolefin comprises at least 90% by weight of the fibril strands and the pigment comprises between 0.05% and 10% by weight of the fibril strands. Preferably, the fibrous sheet material has a basis weight of less than 85 g/m², a delamination strength of at least 60 N/m, and an opacity of at least 90% if the sheet has a delamination strength less than 120 N/m, an opacity of at least 85% if the sheet has a delamination strength between 120 N/m and 150 N/m, and an opacity of at least 80% if the sheet has a delamination strength greater than 150 N/m.

The polyolefin polymer of the gas permeable, fibrous sheet material is preferably selected from the group of polyethylene, polypropylene, and copolymers comprised primarily of ethylene and propylene units, and is more preferably polyethylene. According to the preferred embodiment of the invention, at least 85% of the pigment in the gas permeable, fibrous sheet material is titanium dioxide. Preferably, the titanium dioxide consists essentially of particles of rutile titanium dioxide having an average particle size of less than 0.75 microns, and the titanium dioxide comprises between 2% and 6% by weight of the fibril strands. A preferred fibrous sheet has a bar code readability, according to ANSI Standard X3.182-1990, of at least 2.0, and an opacity of at least 92%.

According to an alternative embodiment of the invention, at least 90% of the pigment in the gas permeable, fibrous sheet material may be a color pigment having a chroma value greater than 0. Preferably, such color pigment comprises between 0.05% and 3% by weight of the fibril strands, and the sheet has an opacity of at least 90%.

It is further preferred that the fibrous sheet of the gas permeable package have a delamination strength of at least 70 N/m, a Gurley Hill Porosity, measured according to TAPPI T-460 OM-88, of less than 60 seconds, and a spore log reduction value, measured according to ASTM F 1608-95, of at least 2.5. The gas permeable package of the invention may be further comprised of a gas impermeable substrate bonded to the gas permeable, fibrous sheet material. The gas impermeable substrate is preferably comprised of a material selected from the group of gas impermeable films, moldable films, and rigid substrates. The gas permeable package of the preferred embodiment of the invention further comprises a thermoplastic adhesive that holds the gas permeable, fibrous sheet material to the gas impermeable substrate.

### BRIEF DESCRIPTION OF THE DRAWINGS

A more thorough explanation of the invention will be provided in the detailed description of the preferred embodiments of the invention in which reference will be made to the following drawings:

FIG. 1 is a cross-sectional view of a sterile package.

FIG. 2 is plan view of another sterile package.

FIG. 3 is a cross-sectional view of the sterile package shown in FIG. 2.

FIG. 4 is a schematic drawing of an apparatus for flash-spinning polyolefin polymer into a plexifilamentary film-fibril web and laying down the web as a batt on a moving surface, which batt is consolidated to sheet form.

FIG. 5 is a graph showing opacity values for a number of different plexifilamentary spunbonded sheets at various delamination strengths.

FIG. 6 is a graph showing the bar code quality values for a number of different plexifilamentary spunbonded sheets at various delamination strengths.

FIG. 7 is a graph showing opacity values for a number of different plexifilamentary spunbonded sheets at various delamination strengths.

FIG. 8 is a graph showing chroma color saturation values for a number of different plexifilamentary spunbonded sheets at various delamination strengths.

FIG. 9 is a graph showing light transmission through seals made at various temperatures where the seal bar was pressed against the materials being sealed for five seconds.

FIG. 10 is a graph showing light transmission through seals made at various temperatures where the seal bar was pressed against the materials being sealed for seven seconds.

### DETAILED DESCRIPTION

The present invention is directed to a sterile package that is made using a gas permeable spunbonded plexifilamentary sheet material. The sterile package of the invention offers all of the advantages of traditional sterile packaging made with spunbonded plexifilamentary sheet material. Namely, the package of the invention is strong, it is permeable to a sterilizing gas, it is impermeable to bacteria, and it does not tear in a manner that generates particulates upon being opened. In addition, as compared to known sterile packages made with spunbonded plexifilamentary sheet material, the package of the invention is more readily printable, it can be manufactured and sealed over a wider range of pressures, temperatures and manufacturing speeds, and it can be more readily heated during package manufacture and sealing.

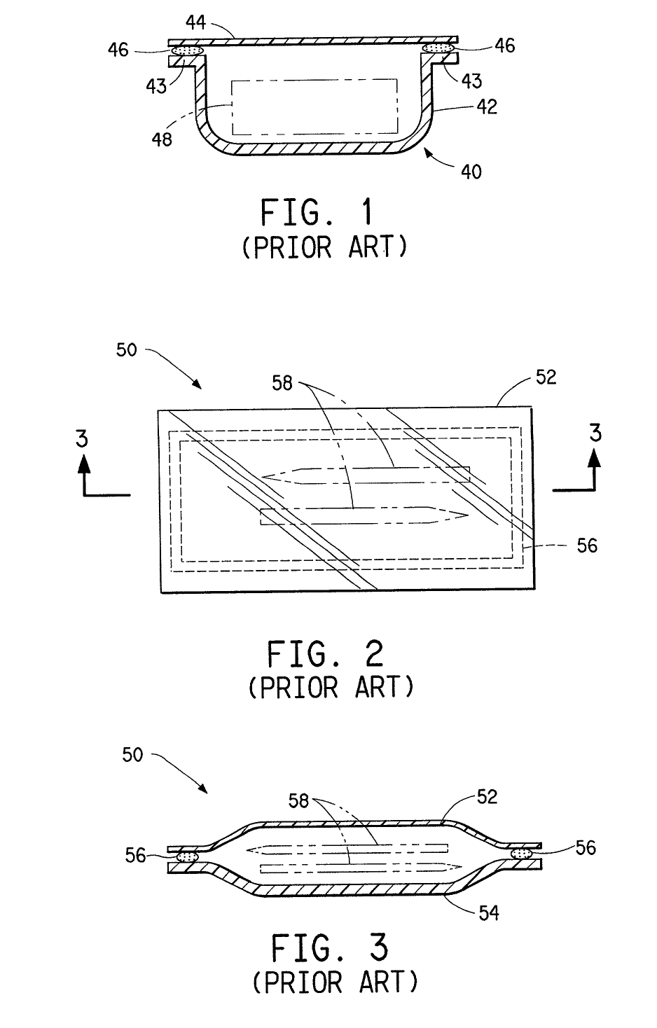

The sterile package of the present invention may have one of the constructions described in the background section above or it may be made using an alternative construction. For example, the sterile package of the invention could be made from a single sheet of spunbonded plexifilamentary sheet material folded over on itself and sealed with an adhesive along the top and side edges. Alternatively, the sterile package of the invention could be made in a manner similar to that shown in FIGS. 2 and 3 wherein the film 54 is replaced with a flat and rigid substrate, as for example a sheet of hard plastic or paperboard. Other constructions of the sterile package according to the invention are contemplated, so long as the construction incorporates the improved spunbonded plexifilamentary sheet material described below.

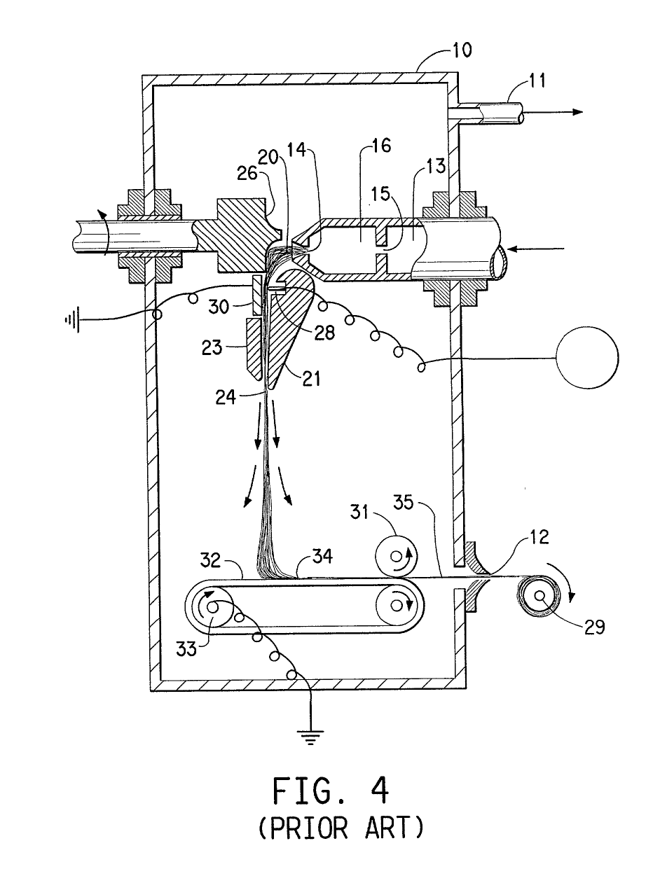

The improved spunbonded plexifilamentary sheet material that is used in the sterile package of the invention and in the packaging process of the invention is made from a thermoplastic polymer with a small amount of pigment dispersed throughout the polymer. The spunbonded plexifilamentary sheet that forms a part of the sterile package of the invention is produced by flash-spinning. Referring now to FIG. 4, an apparatus and process for flash-spinning a thermoplastic polymer is illustrated. This flash-spinning process is known in the art. The process is conducted in a chamber 10, sometimes referred to as a spin cell, which has a solvent-removal port 11 and an opening 12 through which non-woven sheet material produced in the process is removed. Polymer solution (or spin liquid) is continuously or batch-wise prepared at an elevated temperature and pressure in a mixing system or supply tank (not shown). The pressure of the solution is greater than autogenous pressure, and preferably greater than the cloud-point pressure for the solution. Autogenous pressure is the equilibrium pressure of the polymer solution in a closed vessel, filled with only solution having both liquid and vapor phases therein, and wherein there are no outside influences or forces. Autogenous pressure is a function of temperature. By providing the solution at greater than autogenous pressure, it is assured that the solution will not have any separate vapor phase present therein. The cloud-point pressure of the solution is the lowest pressure at which the polymer is fully dissolved in the solvent so as to form a homogeneous single phase mixture.

The polymer solution is admitted from the supply tank through a pressurized supply conduit 13 and an orifice 15 into a lower pressure (or letdown) chamber 16. In the lower pressure chamber 16, the solution separates into a two-phase liquid-liquid dispersion, as is disclosed in U.S. Pat. No. 3,227,794 to Anderson et al., which is hereby incorporated by reference. One phase of the dispersion is a solvent-rich phase comprising primarily solvent and the other phase of the dispersion is a polymer-rich phase containing most of the polymer. This two phase liquid-liquid dispersion is forced through a spinneret 14 into an area of much lower pressure (preferably atmospheric pressure) where the solvent expands and evaporates very rapidly (flashes), and the thermoplastic polymer emerges from the spinneret as a plexifilamentary strand 20. The strand 20 is directed against a rotating baffle 26. Preferably, the rotating baffle 26 has a shape that transforms the strand 20 into a flatter web 24 of about 5-15 cm in width. The rotating baffle 26 directs the web 24 in a back and forth oscillating motion having sufficient amplitude to generate a wide swath on a laydown belt 32. The web 24 is laid down on the moving wire laydown belt 32 located about 50 cm below the rotating baffle 26, and the back and forth oscillating motion is directed generally across the belt 32 to form a batt 34.

After the web 24 is deflected by the baffle 26 on its way to the moving belt 32, the web enters a corona charging zone between a stationary multi-needle ion gun 28 and a grounded rotating target plate 30. The charged web 24 is carried by a high velocity solvent vapor stream through a diffuser consisting of a front section 21 and a back section 23. The diffuser controls the expansion of the spin agent gases and slows the web 24 down. The moving belt 32 is grounded through roll 33 so that the charged web 24 is electrostatically attracted to the belt 32 and is pinned in place thereon. Overlapping web swaths collected on the moving belt 32 are held there by electrostatic forces and are formed into the batt 34 with a thickness controlled by the spin liquid flow rate and the speed of belt 32. The batt 34 is compressed between belt 32 and consolidation roll 31 into a sheet 35 having sufficient strength to be handled outside the chamber 10 and collected on a windup roll 29.

The lightly consolidated film-fibril sheet 35 is conventionally bonded according to a thermal bonding process like that disclosed in U.S. Pat. No. 3,532,589 to David (assigned to DuPont). According to this process, an unconsolidated film-fibril sheet is subjected to light compression during heat bonding on a large roll bonder in order to prevent shrinkage and curling of the bonding sheet. A flexible belt is used to compress the sheet material being bonded as the sheet is bonded against a large heated drum that is made of a heat-conducting material. The heated and bonded sheet is removed from the heated drum without removing the belt restraint and the sheet is then transferred to a cooling roll where the temperature of the film-fibril sheet throughout its thickness is reduced to a temperature less than that at which the sheet will distort or shrink when unrestrained. The sheet may be subsequently run through another thermal bonding device like that just described with the opposite surface of the sheet facing the heated drum in order to produce a hard bonded surface on both sides of the sheet. Alternatively, the lightly consolidated film-fibril sheet 35 may be point-bonded by passing the sheet between a heated roll with raised bosses and a resilient roll, as described in U.S. Pat. No. 3,478,141 to Dempsey et al. (assigned to DuPont). Where softer flash-spun sheet is desired, the point-bonded sheet may be softened by passing the sheet through a button breaking and creping device, as described in U.S. Pat. No. 3,427,376 to Dempsey et al. (assigned to DuPont).

Typical polymers used in the flash-spinning process are polyolefins, such as polyethylene and polypropylene. It is also contemplated that copolymers comprised primarily of ethylene and propylene monomer units, and blends of olefin polymers and copolymers could be flash-spun as described above. It has been found that it is possible to make flash-spun polyolefin sheet material according to the processes described above, but with a small amount of pigment dispersed throughout the polymer. Such pigment has been found to increase the opacity of the flash-spun sheet, especially where the sheet is subjected to elevated levels of thermal bonding. It has also been found that the dispersion of certain pigments in a flash-spun polyolefin sheet make matter printed on such sheets more readable by both the human eye and electronic scanning equipment. Pigmented flash-spun polyolefin sheets, when incorporated into sterile packages, improve the ability of the packages to carry printed messages, including bar codes. This is very beneficial when the packaged item is something like a medical device that is often accompanied by extensive written disclosure. Using pigmented flash-spun polyolefin sheets in sterile packages also makes it possible to manufacture the packages over a wider range of pressures, temperatures and manufacturing speeds, without the packaging becoming transparent.

A white pigment that has been found to be an especially beneficial additive in flash-spun polyolefin sheets is titanium dioxide. The addition of a small amount of titanium dioxide to a polyolefin polymer prior to beginning flash-spinning according to the process described above has been found to significantly increase the opacity of the bonded flash-spun sheet. In a process for making such sheets, a mixture of a polyolefin polymer and titanium dioxide is first formed wherein the titanium dioxide comprises between 0.1% and 10% by weight of the mixture, and more preferably from 1% to 5% by weight of the mixture. This mixture is combined with a solvent to form a spin solution at an elevated temperature and pressure. The pressure of the spin solution is greater than autogenous pressure, and preferably greater than the cloud-point pressure for the solution. The solvent preferably has an atmospheric boiling point between 0° C. and 150° C., and is selected from the group consisting of hydrocarbons, hydrofluorocarbons, chlorinated hydrocarbons, halocarbons, hydrochlorofluorocarbons, alcohols, ketones, acetates, hydrofluoroethers, perfluoroethers, and cyclic hydrocarbons (having five to twelve carbon atoms). Preferred solvents for solution flash-spinning polyolefin polymers and copolymers and blends of such polymers and copolymers include trichlorofluoromethane, methylene chloride, dichloroethylene, cyclopentane, pentane, HCFC-141b, and bromochloromethane. Preferred co-solvents that may be used in conjunction with these solvents include hydrofluorocarbons such as HFC-4310mee, hydrofluoroethers such as methyl(perfluorobutyl)ether, and perfluorinated compounds such as perfluoropentane and perfluoro-N-methylmorpholine. This spin solution is subsequently flash-spun from a spin orifice and laid down on a moving belt to form sheets of plexifilamentary film-fibrils according to the flash-spinning process described above and shown in FIG. 4.

The preferred polyolefin in the mixture of titanium dioxide and polyolefin is polyethylene. The titanium dioxide is preferably added to the mixture in the form of particles having an average particle size of less than 0.5 microns. The titanium dioxide particles are first compounded into polyethylene at an on-weight-polymer loading of between 10% and 80% by weight to form a concentrate. The concentrate is next blended with a high density polyethylene, preferably having a melt index of between 0.65 and 1.0 g/10 minutes at 1900° C. and a density of between 0.940 and 0.965 g/cc, such that the titanium dioxide comprises between 0.10% and 10% by weight of the mixture. This mixture of polyethylene and titanium dioxide is combined with a spinning solvent, as described above, prior to flash-spinning. It is contemplated that the titanium dioxide could alternatively be injected directly into the spin solution.

The titanium dioxide particles used in the invention are generally in rutile or anatase crystalline form, and the particles are commonly made by either a chloride process or a sulfate process. The titanium dioxide particles may also contain ingredients to improve the durability of the particles or the dispersability of the particles in the polymer. By way of example, and not limited thereto, the titanium dioxide used in the invention may contain additives and/or inorganic oxides, such as aluminum, silicon or tin as well as triethanolamine, trimethylolpropane, and phosphates. Preferably, the titanium dioxide particles have been treated with about 0.1% to about 5% by weight, based on the weight of the titanium dioxide, of at least one organosilicon compound, such as a silane or a polysiloxane to improve the stability of the mixture of polymer, titanium dioxide and spin agent. One preferred compound is a silane having the formula: RₓSi(R′)₄₋ₓ wherein: R is a nonhydrolyzable aliphatic, cycloaliphatic or aromatic group having 8-20 carbon atoms; R′ is a hydrolyzable group selected from alkoxy, halogen, acetoxy or hydroxy or mixtures thereof; and x=1 to 3. Such titanium dioxide particles are more fully disclosed in PCT Patent Publication No. WO 95/23192, which is hereby incorporated by reference. The titanium dioxide used in Examples 1 and 2 below was added to the polymer in the form of particles of neutralized pigmentary rutile titanium dioxide treated with 1% by weight of octyl triethoxy silane.

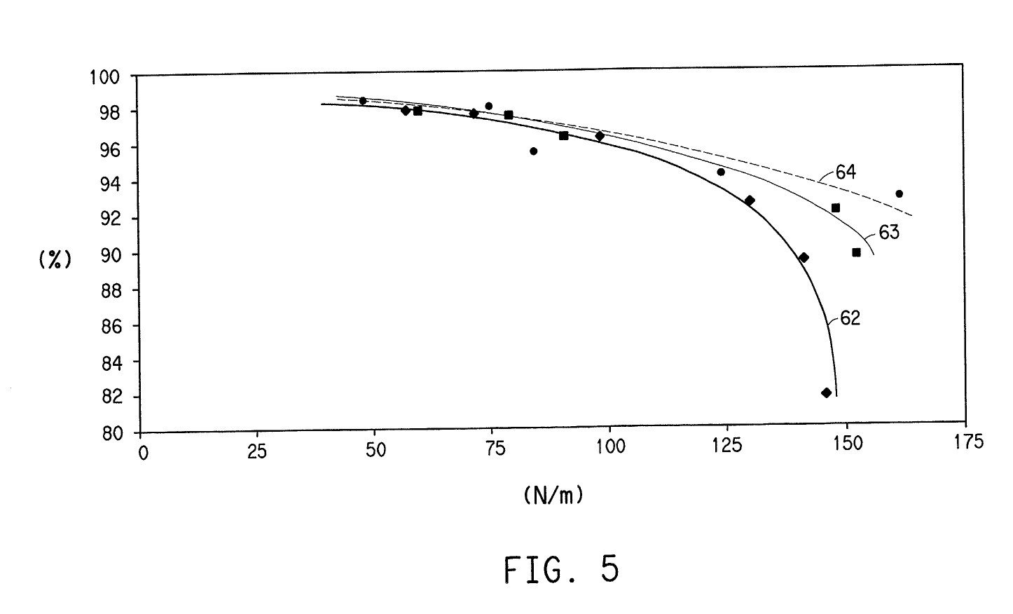

Flash-spun sheets of plexifilamentary film-fibrils of polyethylene and titanium dioxide have been found to exhibit a number of improved properties. For example, at most levels of sheet opacity, the delamination strength of a sheet that includes small amounts of titanium dioxide are significantly greater than the delamination strength of a sheet that is identical, except that it is made without titanium dioxide. FIG. 5 is a graph of opacity vs. delamination strength for the three sheets produced as described in Comparative Example 1 and in Examples 1 and 2. The first sheet (curve 62) had no titanium dioxide added; the second sheet (curve 63) included 2.5% by weight of rutile titanium dioxide treated with silane; and the third sheet (curve 64) included 5% by weight of rutile titanium dioxide treated with silane. As can be seen in FIG. 5, at an opacity level of 93%, the sheet with no titanium dioxide had a delamination strength of about 125 N/m, while the sheet with 2.5% titanium dioxide had a delamination strength of about 140 N/m, and a sheet with 5% titanium dioxide had a delamination strength of about 165 N/m. While the lightly bonded sheets with a delamination strength of about 60 N/m each maintained an opacity of about 98%, at a more bonded delamination strength of about 140 N/m, the sheet with 5% titanium dioxide maintained a 94% opacity while the sheet without titanium dioxide had maintained only a 89.5% opacity. This is because the titanium dioxide containing sheet material withstands a greater degree of thermal bonding without undue reduction in opacity.

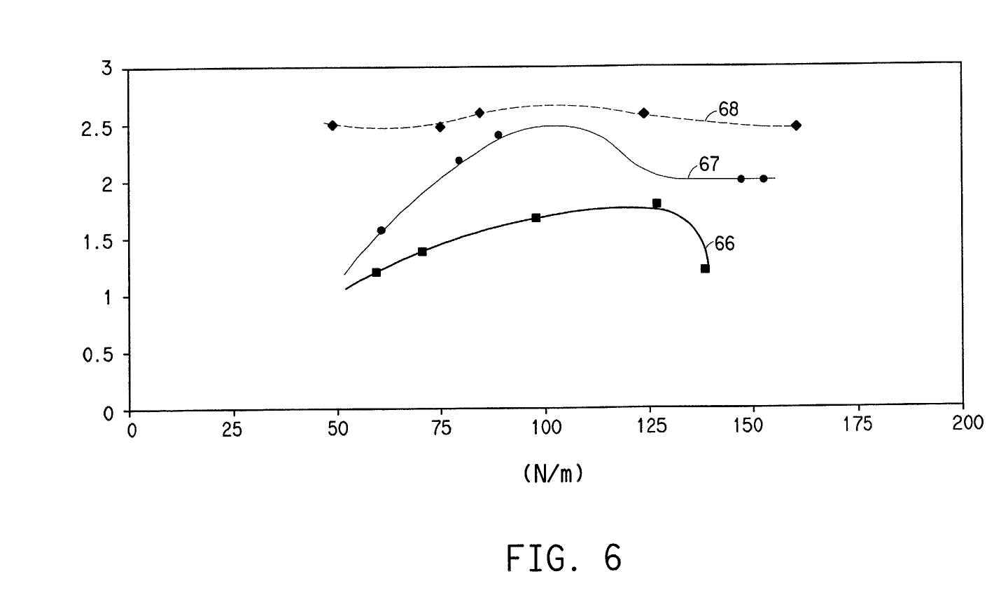

Another marked advantage of sheets flash-spun from a mixture of polyethylene and a minor amount of titanium dioxide is that matter printed on such sheets is more readily discernible. For example, bar codes printed on sheet material that was made with small amounts of titanium dioxide (Examples 1 and 2) were far more readable by bar code reading machines than were the bar codes printed on sheet material that was made without titanium dioxide (Comparative Example 1). As can be seen in FIG. 6, the bar code readability scores for sheets made with either 2.5% titanium dioxide (curve 67) or 5% titanium dioxide (curve 68) were markedly higher than for sheets made without titanium dioxide (curve 66). At a given bonding level, the bar code readability scores for the sheet material with 5% titanium dioxide (Example 1) were, on average, 78% better than the readability scores for the sheet without titanium dioxide (Comparative Example 1). Likewise, the bar code readability scores for the sheet material with 2.5% titanium dioxide of (Example 2) were, on average, 41% better than the readability scores for the sheet without titanium dioxide (Comparative Example 1). Without wishing to be bound by theory, it is believed that this improvement results from two factors. First, the sheet with titanium dioxide reflects more light at the surface such that the contrast between the dark bars and the sheet is more pronounced. Second, because the sheet with titanium dioxide can be subjected to a greater degree of thermal bonding without significant loss of opacity, this sheet can be made with a smoother more reflective surface, which results in even greater visual contrast between the sheet and the printed matter. This improved readability is very beneficial when the sheet material is used in sterile packaging where a high degree of printability offers significant utility.

Bonded plexifilamentary sheet material is more easily printed if the surface of the sheet is smooth. A smooth sheet surface requires far less ink than a rough surface because a smooth surface does not have pits and crevices that absorb significant quantities of ink as is the case with a rough or textured surface. Ink printed on a smooth surface stays at the surface where the ink makes the maximum contribution to the printed image. The thin and uniform layer of ink needed to produce an image on a smooth surface also dries faster, and is therefore more smudge resistant, than the thicker and less uniform layer of ink required to produce a printed image on a rough or textured surface.

Bonded plexifilamentary sheet material is not inherently smooth because such sheet material is made up of fine fibers with high surface areas that have been laid down on top of each other. In order to obtain a smooth readily printable surface on a sheet of bonded plexifilamentary sheet material it may be necessary to subject the sheet to higher temperature bonding. It has also been found that a highly printable smooth sheet surface can be obtained by passing the bonded sheet material between smooth calender rolls. However, when high bonding temperatures and/or post-bonding calendering is applied to plexifilamentary sheet material, the opacity of the sheet material goes down. As has been discussed above, printed matter on a less opaque sheet material is considerably less clear than matter printed on a more opaque sheet. Thus, much of the improvement in printability of a conventional plexifilamentary sheet that can be obtained by making the surface smoother is lost due to reduced opacity.

Incorporating a small amount of pigment, such as titanium dioxide, into the polymer used in flash-spinning a plexifilamentary sheet material permits the sheet to be bonded and/or calendered to make the sheet smoother, and more printable, without sacrificing opacity. As can be seen in the Examples reported in Table 8 (Comparative Example 4, Example 8 and Example 11), the addition of titanium dioxide to the polymer used in making flash-spun plexifilamentary sheet material helps the sheet material maintain greater opacity when the sheet is subjected to cold calendering in order to improve sheet smoothness. Similarly, the Examples reported in Table 9 (Comparative Example 5, Example 9 and Example 12), demonstrate that the addition of titanium dioxide helps a plexifilamentary sheet material maintain greater opacity when the sheet is subjected to hot calendering in order to improve sheet smoothness. It can also be seen that both the cold calendered sheets to which titanium dioxide had been added of Examples 8 and 11 (Table 8) and the hot calendered sheet to which titanium dioxide had been added of Examples 9 and 12 (Table 9) were far more bar code scanable than the sheets without titanium dioxide (Comparative Examples 4 and 5). In Examples 13-21 it can be seen that the improved sheet opacity and bar code scanability that has been found to result from the addition of titanium dioxide to a plexifilamentary sheet are evident over a range of sheet basis weights.

Colored pigments can also be used to improve the physical properties of bonded sheets of flash-spun plexifilamentary film-fibrils. A small amount of certain concentrated color pigments can increase a flash-spun sheet's opacity, improve the sheet's stability to UV radiation, and/or improve the sheet's visual uniformity. A concentrate of a color pigment in a polymer can be dispersed in the polymer that is to be flash-spun. Preferably, the concentrate is a mixture of a polyethylene and color pigment in which the color pigment comprises between 5% and 60% by weight of the concentrate. Preferably, pellets of the concentrate and the polyethylene are introduced into the solutioning system by loss-in-weight feeders in a controlled manner such that the pigment comprises from 0.05% to 5.0% by weight of the polymer that is to be flash-spun. The mixture of polyethylene and color pigment is combined with one of the solvents described above to form a spin solution at an elevated temperature and pressure. This spin solution is subsequently flash-spun from a spin orifice and laid down to form sheets of plexifilamentary film-fibrils according to the flash-spinning process described above and shown in FIG. 4.

Color pigments used in flash-spinning should not be pigments that react with the spin agent. For example, color pigments that are unstable in acid environments should not be used with trichlorofluoromethane spin agents that are commonly used in flash-spinning high density polyethylene. One such color pigment that has been found to be unstable in trichlorofluoromethane spin agent is Ampacet's ultramarine blue (CI No. 77007). The color pigment should also be one that does not degrade at the elevated temperatures commonly applied to the spinning solution during solution flash-spinning of polyolefins (e.g., 180° to 200° C. for polyethylene). It is also important that the color pigment not destabilize the polymer, either during flash-spinning or in the finished sheet product. For example, pigments made with transition metals, as found in inorganic complex pigments like barium red pigment, have been found to promote oxidative degradation of flash-spun polyethylene sheet.

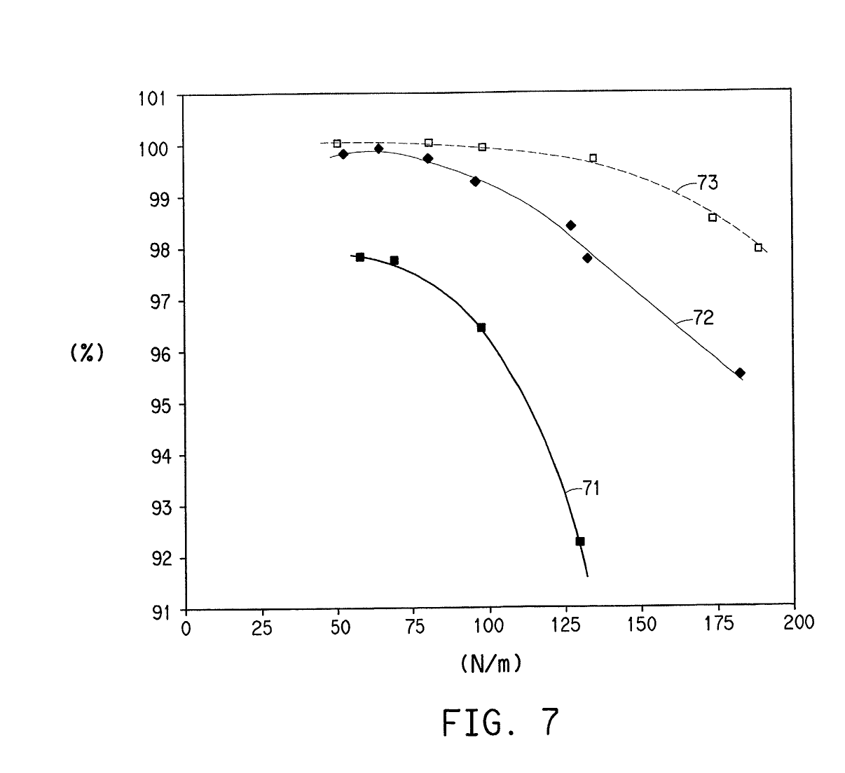

Bonded sheets into which the color pigments have been incorporated have been found to exhibit opacity after thermal bonding that is far superior to the opacity of a bonded sheet that is identical except for the absence of a pigment additive. As can be seen in FIG. 7, flash-spun polyethylene sheets that were produced with about 0.4% blue pigment (curve 73), as described in Example 3, or about 1.64% red pigment (curve 72), as described in Example 4, had opacities that remained above 98% even after the sheets were steam bonded to a delamination strength of up to 125 N/m. The opacity of the unpigmented sheet of Comparative Example 1 (curve 71) dropped to 91% when bonded to a delamination strength of 125 N/m. FIG. 7 shows that a high delamination strength can be achieved in the pigmented sheets made with a very small amount of color pigment with almost no loss in opacity. It has also been found that bonded flash-spun polyethylene sheet made with either white pigment, colored pigment, or some combination of the two has a much more uniform overall appearance in which the swirl patterns of the plexifilamentary web was much less visible than in comparable unpigmented sheet material.

Another surprising finding has been the degree to which color richness and color saturation in a sheet of flash-spun pigmented sheet product improves when the pigmented sheet of the invention is thermally bonded. Color saturation is one of the three attributes of color commonly used to characterize a color. In a three-dimensional color system, such as the Munsell System of Color Notation, color can be defined in terms of lightness, hue and saturation. According to this system, lightness from black to white is reported on a vertical axis. The hue is reported in terms of a direction perpendicular to the vertical axis which corresponds to a particular color on a hue circle that surrounds the vertical axis. The saturation of the color is reported in terms of a distance from the vertical axis. Colors that are further from the black-white vertical axis are less gray and are more saturated with the pure color hue. This degree of color saturation is not dependent on hue, and is expressed in the unitless measure of chroma.

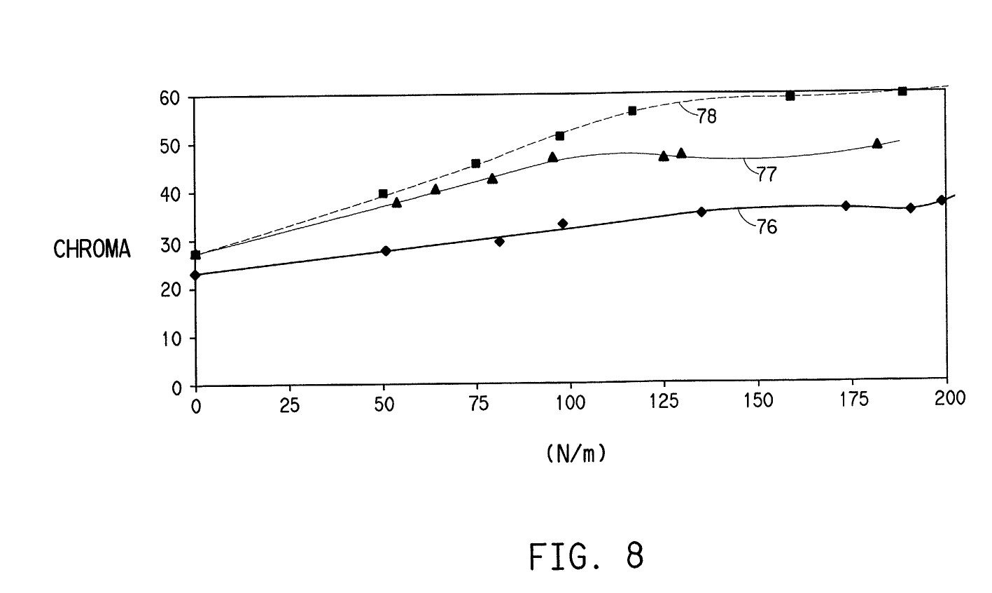

As can be seen in FIG. 8, the chroma of flash-spun polyethylene sheets that were produced with about 0.4% blue pigment (curve 76), as described in Example 3, about 1.64% red pigment (curve 77), as described in Example 4, or about 1.0% yellow pigment (curve 78), as described in Example 5 had chroma values that increased from 20% to 40% when bonded to a relatively low delamination strength of about 50 N/m. The chroma values for the sheets when bonded to delamination strengths greater than 150 N/m were from 60% to 105% greater than the chroma values for the corresponding unbonded sheets.

As discussed above, a bonded plexifilamentary film fibril sheet becomes more printable if it is made with a smoother surface. On a smoother sheet, printed ink is not lost in grooves or crevices where the lost ink does not contribute to the printed image. One way to make a bonded sheet smoother is the application of calender pressure to the sheet after the sheet has already been bonded. As can be seen in Tables 7, 8, and 9, sheet print quality is not greatly improved by cold or hot calendering alone (Comp. Example 3 and Example 4 and 5). However, when titanium dioxide pigment is incorporated into the flash-spun polymer, cold and hot calendering were found to improve print quality (Examples 7-12). Examples 13-21 show that over a range of sheet basis weights, calendering a bonded sheet into which titanium dioxide pigment was incorporated resulted in a more printable sheet product. It should be noted that corona treatment of the sheets of Examples 7-21 and the use of an antistatic agent (ZELEC®-TY) are also believed to contribute to improved sheet printablility.

The addition of titanium dioxide to flash-spun plexifilamentary sheet material has been found to significantly improve sheet opacity in thinner areas of the sheet. As can be seen in Table 11, the addition of about 4% titanium dioxide to flash-spun polyethylene plexifilamentary sheet material provides a significant improvement in the general opacity of the sheet material. More significantly, the opacity in the thin areas of the sheets to which titanium dioxide had been added (Examples 22 and 23) was dramatically better than the opacity in the thin areas of the sheets to which no titanium dioxide had been added (Comparative Examples 6 and 7). Of importance to the use of the sheet material of Examples 22 and 23 in packaging applications is that the air porosity and microbial barrier properties of these sheet materials are not compromised by the addition of about 4% titanium dioxide. In addition for certain medical packaging applications, due to the absence of regulatory approval, it may not be possible to use antistatic agents or corona treatments to improve print quality on the flash spun plexifilamentary sheet material. As can be seen in Example 22, the improvement in print quality stemming from the addition of titanium dioxide becomes all the more important when antistatic agents and corona treatment are not used.

The incorporation of titanium dioxide pigment into a spunbonded sheet has also been found to improve opacity in a plexifilamentary sheet that is flash-spun using a hydrocarbon solvent. As can be seen in Example 24, the addition of 3.5% titanium dioxide to a flash-spun sheet material spun from a hydrocarbon-based spin agent produced a bonded sheet with excellent opacity.

When a flash-spun plexifilamentary polymer sheet is thermally bonded to a film, as is common in the manufacture of packaging, the heat sealing of the sheet with titanium dioxide pigment results in seals that are far more opaque than the seals generated on sheets without such pigment. Table 13 shows that the light transmitted through thermal seals made with a sheet containing 3.6% titanium dioxide pigment (Example 24) was significantly less than was transmitted through seals made using sheet material that did not include such pigment (Comp. Example 8). The seals made using the sheet material with titanium dioxide (Example 24) were able to be made using longer dwell times and/or higher temperature without causing the seals to become transparent. This was not possible when the sheet material without titanium dioxide (Comp. Example 8) was used. Thus, the sheet material with titanium dioxide of Example 24 makes it possible to form package seals over a greater range of temperatures and dwell times than would be possible with the conventional sheet material of Comp. Example 8. This increases package manufacturing flexibility and makes possible higher rates of packaging production.

When the sheet materials of Example 22 and Comparative Example 6 were actually used to make form-fill-seal packages, the package of Comparative Example 9, that was made using the flash-spun polyethylene sheet without titanium dioxide pigment of Comparative Example 6, had obvious thin spots in the gas permeable sheet material and the seals were transparent. On the other hand, when a form-fill-seal package of Example 26 was made using the flash-spun polyethylene sheet with 3.6% titanium dioxide pigment of Example 22, the package had a pleasing uniform appearance without obvious thin spots and the seals were not transparent.

The following examples demonstrate that a package made according to the invention is more readily printable, can be manufactured and sealed over a wider range of pressures, temperatures and manufacturing speeds, and can be more readily heated during package manufacture and sealing than packages previously know in the art. The improvements that are realized with the present invention are made more apparent in the following non-limiting examples.

### EXAMPLES

In the description above and in the non-limiting examples that follow, the following test methods were employed to determine various reported characteristics and properties. ASTM refers to the American Society for Testing and Materials, TAPPI refers to the Technical Association of the Pulp and Paper Industry, ISO refers to the International Organization for Standardization, and ANSI refers to the American National Standards Institute.

Basis Weight was determined by ASTM D-3776, which is hereby incorporated by reference, and is reported in g/m². The basis weights reported for the examples below are each based on an average of at least twelve measurements made on the sheet.

Delamination Strength of a sheet sample is measured using a constant rate of extension tensile testing machine such as an Instron table model tester. A 1.0 in. (2.54 cm) by 8.0 in. (20.32 cm) sample is delaminated approximately 1.25 in (3.18 cm) by inserting a pick into the cross-section of the sample to initiate a separation and delamination by hand. The delaminated sample faces are mounted in the clamps of the tester which are set 1.0 in (2.54 cm) apart. The tester is started and run at a cross-head speed of 5.0 in/min (12.7 cm/min). The computer starts picking up force readings after the slack is removed in about 0.5 in. of crosshead travel. The sample is delaminated for about 6 in (15.24 cm) during which 3000 force readings are taken and averaged. The average delamination strength is the average force divided by the sample width and is expressed in units of N/cm or N/m. The test generally follows the method of ASTM D 2724-87, which is hereby incorporated by reference. The delamination strength values reported for the examples below are each based on an average of at least twelve measurements made on the sheet.

Opacity is measured according to TAPPI T-425 om-91, which is hereby incorporated by reference. The opacity is a measure of the amount of light reflected from a single sheet placed over a black background divided by the same measure of the amount of light reflected from the same sheet placed over a white background, which value is multiplied by 100 to obtain the percent opacity. The opacity values reported for the examples below are each based on an average of at least six measurements made on the sheet. Thin Spot Opacity was measured by first identifying thin spots in the sheet by placing the sheet on a table with a black top. Areas where black could be seen though the sheet were identified and marked as thin spots. Thin spot opacity was measured according to TAPPI T-425 om-91 using samples from nine thin spots in the sheet, taking two readings of opacity on each sample and averaging all eighteen readings.

Light Transmission is determined using a Macbeth densitometer. The Macbeth densitometer measures the optical density of a sample film clamped between a light source and a light sensor. The aperture of both light source and sensor is about a 1/16 inch in diameter. Essentially all the light penetrating the film is captured by the sensor. The optical density is a measure of the log of the intensity of the transmitted light divided by the intensity of the incident light (I/I₀). I/I₀, the transmittancy, is multiplied 100 to obtain the light transmission in percent.

Print Quality is measured according to ANSI X3.182-1990, which is hereby incorporated by reference. The test measures the print quality of a bar code for purposes of code readability. The test evaluates the print quality of a bar code symbol for contrast, modulation, defects, and decodability and assigns a grade of A, B, C, D or F(fail) for each category. The additional categories of reflectance and edge contrast are evaluated on a pass/fail basis. The overall grade of a sample is the lowest grade received in any of the above categories. The bar code quality numerical values reported in the examples below represent an average of 80 scans, wherein a grade of A=4, a grade of B=3, a grade of C=2, a grade of D=1, and a grade of F=0. For each sample, ten scans were made on eight different bar codes printed on the sample, for a total of 80 scans. The ANSI grades were assigned as follows:

| BAR CODE RATING | A | B | C | D | F |
|---|---|---|---|---|---|
| Symbol Contrast | >70 | >55 | >40 | >20 | <20 |
| Edge Contrast | >15 | | | | <15 |
| Modulation | >70 | >60 | >50 | >40 | <40 |
| Decodability | >62 | >50 | >37 | >25 | <25 |
| Defects | <15 | <20 | <25 | <30 | >30 |

The testing was done with Code 39 symbology bar codes with the narrow bar width of 0.0096 inch (0.0244 cm) that were printed with an Intermec 4400 Printer manufactured by Intermec Inc. of Cincinnati, Ohio, using thermal transfer ribbon B110A made by Ricoh Electronics of Japan. Verification was done with a PSC Quick Check 200 scanner (660 nm wavelength and 6 mil aperture) manufactured by Photographic Sciences Corporation Inc. of Webster, N.Y.

Melt Index is measured according to ASTM-D-1238-90A and is expressed in units of g/10 minutes (@ 190° C. with a 2.16, 5 or 21.6 kg weight).

Chroma is a unitless measurement of color saturation according to the Munsel System of Color Notation. A higher Chroma value is indicative of a richer, more pure color, regardless of the color's hue. Chroma was measured with a MacBeth Model 2020 integrating sphere spectraphotometer manufactured by MacBeth Division of Kollmorgen Corporation of Newburgh, N.Y.

Sheet Thickness was determined by ASTM method D 1777, which is hereby incorporated by reference, and is reported in microns.

Sheet Smoothness was measured using an L&W PPS Tester (commonly know as a Parker Tester) manufactured by Lorentzen & Wettre of Kista, Sweden. The test was run according to the following standard methods TAPPI T 555 and ISO 8781-4, which are hereby incorporated by reference. According to the test, the smoothness or roughness of a sheet is measure by pressing the measuring ring of the Parker Tester against the sheet material being tested. A controlled flow of compressed air is injected into a compartment on the inside of the ring that has a side open to the sheet material being tested. Air passing under the ring enters a chamber on the outside of the ring that has a side open to the sheet material being tested. The air collected in the outside chamber is measured over time and this measurement is used to calculate the roughness (or smoothness) of the sheet surface in units of microns.

Tensile strength was determined by ASTM D 5035-90, which is hereby incorporated by reference, with the following modifications. In the test, a 2.54 cm by 20.32 cm (1 inch by 8 inch) sample was clamped at opposite ends of the sample. The clamps were attached 12.7 cm (5 in) from each other on the sample. The sample was pulled steadily at a speed of 5.08 cm/min (2 in/min) until the sample broke. The force at break was recorded in Newtons/cm as the breaking tensile strength.

Elongation to Break of a sheet is a measure of the amount a sheet stretches prior to failure (breaking)in a strip tensile test. A 1.0 inch (2.54 cm) wide sample is mounted in the clamps-set 5.0 inches (12.7 cm) apart-of a constant rate of extension tensile testing machine such as an Instron table model tester. A continuously increasing load is applied to the sample at a crosshead speed of 2.0 in/min (5.08 cm/min) until failure. The measurement is given in percentage of stretch prior to failure. The test generally follows ASTM D5035-90.

Elmendorf Tear Strength is a measure of the force required to propagate a tear cut in a sheet. The average force required to continue a tongue-type tear in a sheet is determined by measuring the work done in tearing it through a fixed distance. The tester consists of a sector-shaped pendulum carrying a clamp that is in alignment with a fixed clamp when the pendulum is in the raised starting position, with maximum potential energy. The specimen is fastened in the clamps and the tear is started by a slit cut in the specimen between the clamps. The pendulum is released and the specimen is torn as the moving clamp moves away from the fixed clamp. Elmendorf tear strength is measured in Newtons in accordance with the following standard method: ASTM D 5035-90, which is hereby incorporated by reference. The tear strength values reported for the examples below are each an average of at least twelve measurements made on the sheet.

Gurley Hill Porosity is a measure of the permeability of the sheet material for gaseous materials. In particular, it is a measure of how long it takes for a volume of gas to pass through an area of material wherein a certain pressure gradient exists. Gurley-Hill porosity is measured in accordance with ASTM D 726-84 using a Lorentzen & Wettre Model 121D Densometer. This test measures the time required for 100 cubic centimeters of air to be pushed through a one inch diameter sample under a pressure of approximately 4.9 inches of water. The result is expressed in seconds and is frequently referred to as Gurley Seconds.

Bacteria Spore Penetration is measured according to ASTM F 1608-95, which is hereby incorporated by reference. According to this method, a sheet sample is exposed to an aerosol of bacillus subtilis var. niger spores for 15 minutes at a flow rate through the sample of 2.8 liters/min. Spores passing through the sample are collected on a media and are cultured and the number of cluster forming units are measured. The log reduction value (“LRV”) expresses the difference, measured in log scale, between the number of cluster forming units on the control media and the number of cluster forming units on the media that was behind the sample. For example, an LRV of 5 represents a difference of 100,000 cluster forming units.

### COMPARATIVE EXAMPLE 1

Plexifilamentary polyethylene was flash-spun from a solution consisting of 18.7% of linear high density polyethylene and 81.3% of a spin agent consisting of 32% cyclopentane and 68% normal pentane. The polyethylene had a melt index of 0.70 g/l0 minutes (@ 190° C. with a 2.16 kg weight), a melt flow ratio {MI (@ 190° C. with a 2.16 kg weight)/MI (@ 190° C. with a 21.6 kg weight)} of 34, and a density of 0.96 g/cc. The polyethylene was obtained from Lyondell Petrochemical Company of Houston, Tex. under the tradename ALATHON®. ALATHON® is currently a registered trademark of Lyondell Petrochemical Company. The solution was prepared in a continuous mixing unit and delivered at a temperature of 185° C., and a pressure of about 13.8 MPa (2000 psi) through a heated transfer line to an array of six spinning positions. Each spinning position had a pressure letdown chamber where the solution pressure dropped to about 6.2 MPa (900 psi). The solution discharged from each letdown chamber to a region maintained near atmospheric pressure and at a temperature of about 50° C. through a 0.871 mm (0.0343 in) spin orifice. The flow rate of solution through each orifice was about 106 kg/hr (232 lbs/hr). The solution was flash-spun into plexifilamentary film-fibrils that were laid down onto a moving belt, consolidated, and collected as a loosely consolidated sheet on a take-up roll as described above.

The sheet was bonded on a Palmer bonder by passing the sheet between a moving belt and a rotating heated smooth metal drum with a diameter of about feet. A Palmer bonder bonds sheet in a manner similar to the bonder disclosed in U.S. Pat. No. 3,532,589 to David. The drum was heated with pressurized steam and the bonding temperature of the drum was controlled by adjusting the pressure of the steam inside the drum. The pressurized steam heated the bonding surface of the drum to approximately 133° to 137° C. The pressure of the steam was used to adjust the temperature of the drum according to the degree of bonding desired. The bonded sheet had the opacity, delamination strength and bar code readability properties set forth in Table 1.

TABLE 1

| Steam Pressure | Basis Weight | Opacity | Delamination | Bar Code |
|---|---|---|---|---|
| (KPa) | (g/m2) | (%) | Strength (N/m) | Readability |
| 324 | 58.3 | 97.8 | 59.5 | 1.2 |
| 338 | 57.3 | 97.7 | 70.1 | 1.4 |
| 352 | 57.6 | 96.4 | 98.1 | 1.7 |
| 372 | 57.3 | 92.3 | 127.8 | 1.8 |
| 386 | 57.0 | 89.4 | 140.1 | 1.2 |
| 400 | 57.6 | 81.7 | 147.1 | |

### EXAMPLE 1

In this Example the polyethylene of Comparative Example 1 was flash-spun under conditions like those described in the Comparative Example 1 with the exception that titanium dioxide was added to the polyethylene before the polyethylene was mixed with the solvent. A concentrate was formed by compounding Type R104 neutralized rutile titanium dioxide into linear low density polyethylene, with a melt index of 3.0 g/10 min at 190° C. and a density of 0.917 g/cc, at 50% on-weight-polymer loading. The titanium dioxide had a mean particle size diameter of about 0.5 microns, and had been sprayed with 1% (by weight of the titanium dioxide) octyl triethoxy silane. This concentrate was obtained in pelletized form from Ampacet Corporation of Tarrytown, N.Y. under the name Pigment White 6(CI No. 77891). The concentrate was subsequently tumble blended with a quantity of the high density polyethylene used in Comparative Example 1. The resulting mixture was comprised of 95% polyethylene and 5% rutile titanium dioxide. This mixture was added to the solvent of Comparative Example 1 in the same proportions as Comparative Example 1 to form a spin solution. The spin solution was subsequently flash-spun under conditions identical to Comparative Example 1 to produce a consolidated sheet. The sheet was thermally bonded on a Palmer bonder as described in Comparative Example 1. The bonded sheet had the opacity, delamination strength and bar code readability properties set forth in Table 2.

TABLE 2

| Steam Pressure | Basis Weight | Opacity | Delamination | Bar Code |
|---|---|---|---|---|
| (KPa) | (g/m2) | (%) | Strength (N/m) | Readability |
| 324 | 60.0 | 98.5 | 49.0 | 2.5 |
| 338 | 60.0 | 98.1 | 75.3 | 2.5 |
| 352 | 60.4 | 95.5 | 84.1 | 2.6 |
| 372 | 60.0 | 94.3 | 124.3 | 2.6 |
| 386 | 59.7 | 93.1 | 161.1 | 2.5 |

### EXAMPLE 2

In this Example the polyethylene was flash-spun under conditions like those described in the Example 1 with the exception that the titanium dioxide and linear low density polyethylene mixture comprised 97.2% polyethylene and 2.5% rutile titanium dioxide. This mixture was prepared in the manner described in Example 1. This mixture was added to the solvent used in both Comparative Example 1 and Example 1 in the same proportions to form a spin solution. The spin solution was subsequently flash-spun under the conditions used in Comparative Example 1 and Example 1 to produce a consolidated sheet. The sheet was thermally bonded on a Palmer bonder as described in Comparative Example 1. The bonded sheet had the opacity, delamination strength and bar code readability properties set forth in Table 3.

TABLE 3

| Steam Pressure | Basis Weight | Opacity | Delamination | Bar Code |
|---|---|---|---|---|
| (KPa) | (g/m2) | (%) | Strength (N/m) | Readability |
| 324 | 56.6 | 97.9 | 61.3 | 1.6 |
| 338 | 57.6 | 97.6 | 80.6 | 2.2 |
| 352 | 57.3 | 96.5 | 91.1 | 2.4 |
| 372 | 57.3 | 92.1 | 147.1 | 2.0 |
| 386 | 57.0 | 89.5 | 152.4 | 2.0 |

### EXAMPLE 3

In this Example the polyethylene of Comparative Example 1 was flash-spun under conditions like those described in Comparative Example 1 with the exception that blue pigment was added to the polyethylene before the polyethylene was mixed with the solvent. A concentrate consisting of polyethylene and blue pigment was prepared as follows: Pigment Blue 15(CI No. 74160) was compounded into linear low density polyethylene, with a melt index of 2.0 g/10 min at 190° C. and a density of 0.924 g/cc, at a 20% on-weight-polymer loading. This concentrate was obtained in pelletized form from Ampacet under the product name Blue PE590547. The pelletized concentrate was subsequently tumble blended with a quantity of the high density polyethylene used in Comparative Example 1. The resulting mixture was comprised of 99.6% polyethylene and 0.4% Pigment Blue 15. This mixture was added to the solvent of Comparative Example 1 in the same proportions as Comparative Example 1 to form a spin solution. The spin solution was subsequently flash-spun under conditions identical to Comparative Example 1 to produce a consolidated sheet. The sheet was thermally bonded on a Palmer bonder as described in Comparative Example 1. The bonded sheet had the opacity, delamination strength and chroma properties set forth in Table 4.

TABLE 4

| Steam Pressure | Basis Weight | Delamination | Opacity | |
|---|---|---|---|---|
| (KPa) | (g/m2) | Strength (N/m) | (%) | Chroma |
| unbonded | 51.9 | NA | 100 | 22.7 |
| 310 | 55.3 | 50.8 | 100 | 27.7 |
| 324 | 56.3 | 82.3 | 100 | 29.9 |
| 338 | 57.3 | 98.1 | 99.9 | 33.6 |
| 352 | 58.3 | 134.8 | 99.6 | 35.5 |
| 372 | 58.0 | 173.4 | 98.64 | 35.8 |
| 386 | 57.6 | 190.9 | 98.02 | 36.1 |
| 400 | 58.0 | 199.6 | 97.06 | 37.2 |

### EXAMPLE 4

In this Example the polyethylene of Comparative Example 1 was flash-spun under conditions like those described in Comparative Example 1 with the exception that red pigment was added to the polyethylene before the polyethylene was mixed with the solvent. A concentrate consisting of polyethylene and red pigment was compounded as follows: 29% Pigment Red 53(CI No. 15585), 12% Pigment Red 48(CI No. 15865) and 9% Pigment White 6(CI No. 77891), and 50% low density polyethylene, with a melt index of 8.0 g/10 min at 190° C. and a density of 0.918 g/cc. The concentrate was obtained in pelletized form from Ampacet under product name Red PE 15151. The pelletized concentrate was subsequently tumble blended with a quantity of the high density polyethylene used in Comparative Example 1. The resulting mixture was comprised of 98% polyethylene, 1.16% Pigment Red 53, 0.48% Pigment Red 48 and 0.36% Pigment White 6. This mixture was added to the solvent of Comparative Example 1 in the same proportions as Comparative Example 1 to form a spin solution. The spin solution was subsequently flash-spun under conditions identical to Comparative Example 1 to produce a consolidated sheet. The sheet was thermally bonded on a Palmer bonder as described in Comparative Example 1. The bonded sheet had the opacity, delamination strength and chroma properties set forth in table 5.

TABLE 5

| Steam Pressure | Basis Weight | Delamination | Opacity | |
|---|---|---|---|---|
| (KPa) | (g/m2) | Strength (N/m) | (%) | Chroma |
| unbonded | 55.3 | NA | 100 | 27.8 |
| 310 | 68.5 | 54.3 | 99.8 | 37.2 |
| 324 | 60.7 | 64.8 | 99.9 | 40.4 |
| 338 | 58.7 | 80.6 | 99.7 | 43.2 |
| 352 | 60.0 | 96.3 | 99.3 | 46.6 |
| 372 | 61.0 | 126.1 | 98.5 | 47.3 |
| 386 | 59.7 | 131.3 | 97.8 | 47.6 |
| 400 | 57.0 | 182.1 | 95.5 | 49.2 |

### EXAMPLE 5

In this Example the polyethylene of Comparative Example 1 was flash-spun under conditions like those described in Comparative Example 1 with the exception that yellow pigment was added to the polyethylene before the polyethylene was mixed with the solvent. A concentrate consisting of polyethylene and yellow pigment was compounded as follows: 24% Pigment Yellow 138(CI No. 56300), 6% Pigment White 6(CI No. 77891) and 1% Pigment Yellow 110(CI No. 56280), and 69% linear low density polyethylene, with a melt index of 20.0 g/10 min at 190° C. and a density of 0.920 g/cc. The concentrate was obtained in pelletized form from Ampacet under the product name Safety Yellow 430191. The concentrate was subsequently tumble blended with a quantity of the high density polyethylene used in Comparative Example 1. The resulting mixture was comprised of 98.76% polyethylene, 0.96% Pigment Yellow 138, 0.24% Pigment White 6 and 0.04% Pigment Yellow 110. This mixture was added to the solvent of Comparative Example 1 the same proportions as Comparative Example 1 to form a spin solution. The spin solution was subsequently flash spun under conditions identical to Comparative Example 1 to produce a consolidated sheet. The sheet was thermally bonded on a Palmer bonder as described in Comparative Example 1. The bonded sheet had the opacity, delamination strength and chroma properties set forth in Table 6.

TABLE 6

| Steam Pressure | Basis Weight | Delamination | Opacity | |
|---|---|---|---|---|
| (KPa) | (g/m2) | Strength (N/m) | (%) | Chroma |
| unbonded | 54.6 | NA | 99.0 | 27.8 |
| 310 | 56.3 | 50.8 | 99.2 | 39.0 |
| 324 | 60.0 | 75.3 | 94.7 | 46.1 |
| 338 | 58.0 | 98.1 | 96.9 | 51.4 |
| 352 | 60.4 | 117.3 | 94.4 | 55.4 |
| 372 | 58.3 | 159.4 | 91.5 | 59.1 |
| 386 | 59.7 | 189.1 | 87.5 | 59.9 |
| 400 | 58.0 | 206.6 | 87.6 | 57.3 |

### EXAMPLE 6

Plexifilamentary polyethylene was flash-spun from a solution of polyethylene and trichlorofluoromethane. The polyethylene was high density polyethylene with a melt index of 0.74 g/10 minutes (@ 190° C. with a 2.16 kg weight), a melt flow ratio {MI (@ 190° C. with a 2.16 kg weight)/MI (@ 190° C. with a 21.6 kg weight)} of 42, and a density of 0.955 g/cc. The polyethylene was obtained from Lyondell Petrochemical Company of Houston, Tex. under the tradename ALATHON® 7026T.

A black pigment was added to the polyethylene before the polyethylene was added to the trichlorofluoromethane solvent. A pelletized concentrate of polyethylene and black pigment was obtained from Ampacet under the product name Black PE 460637. The compound consisted of 10% Pigment Black 7(CI No. 77226) and 90% high density polyethylene, with a melt index of 0.7 g/10 min at 1900° C. and a density of 0.955 g/cc. This concentrate was subsequently tumble blended with a quantity of the high density polyethylene described in the paragraph above. The resulting mixture was comprised of 99.9% polyethylene and 0.1% Pigment Black 7. This mixture was added to the trichlorofluoromethane solvent to form a spin solution of 11% pigmented polyethylene and 89% solvent. The spin solution was prepared in a continuous mixing unit and delivered at a temperature of 190° C. and a pressure of about 13.8 MPa (2000 psi) through a heated transfer line to a pressure letdown chamber where the solution pressure dropped to 8.1 MPa (1180 psi). The solution discharged from the letdown chamber to a region maintained near atmospheric pressure and at 49° C. through one of a linear array of 1.67 mm (0.0656 in) spin orifices. The flow rate of solution through each orifice was about 647 kg/hr (1427 lbs/hr). The solution was flash-spun into plexifilamentary film-fibrils that were laid down onto a moving belt, consolidated to form a sheet, and collected on a take-up roll as described above.

Next the loosely consolidated sheet was embossed and thermally bonded. The sheet was wrapped about 203° around a first rotating 20 inch (50.8 cm) embossing roll that was heated with hot oil to a temperature between 160° and 190° C. and had a fine linen pattern engraved on its surface. The sheet was passed through a 1.25 inch (3.18 mm) nip with a pressure of 600 psi (4.14 MPa) that was formed between the first heated embossing roll and a resilient back-up roll. The sheet was next wrapped about 203° around a second rotating 20 inch (50.8 cm) embossing roll that was heated with hot oil to a temperature between 160° and 190° C. and had a pattern of small ribs engraved on its surface. The sheet was passed through a 1.25 inch (3.18 mm) nip with a pressure of 600 psi (4.14 MPa) formed between the second heated embossing roll and a resilient back-up roll before being transferred to a pin softening apparatus. The pin softening apparatus comprised two sets of two 14 inch (35.57 mm) diameter rolls covered with 0.040 inch (0.102 mm) diameter pins set on a square 0.125 inch (0.318 mm) pattern. The bonded and embossed sheet was passed between the pin rolls of each set. The pin rolls were set so that the pins from one roll of each roll set pushed between the pins of the other roll of the set, with the pin engagement being typically about 0.045 inches (0.102 mm). The bonded and softened sheet had the following properties:

| Basis Weight | 40.7 g/m² |
|---|---|
| Opacity | 100% |
| Chroma | 1.0 |

### COMPARATIVE EXAMPLE 2

In this Example the polyethylene of Example 6 was flash-spun under the conditions described in the Example 6 with the exception that no pigment was added to the polyethylene before the polyethylene was mixed with the solvent. The bonded and softened sheet had the following properties:

| Basis Weight | 40.7 g/m² |
|---|---|
| Opacity | 96.0% |
| Chroma | 0.4 |

### COMPARATIVE EXAMPLES 3-5

Plexifilamentary polyethylene film fibrils were flash-spun from a solution of polyethylene and trichlorofluoromethane spin agent. The polyethylene was high density polyethylene with a melt index of 2.3 g/10 minutes (@ 190° C. with a 5 kg weight), a melt flow ratio {MI (@ 190° C. with a 21.6 kg weight)/MI (@ 190° C. with a 5 kg weight)} of 11, and a density of 0.956 g/cc. The polyethylene was obtained from Hostalen GmbH of Frankfurt, Germany, under the tradename HOSTALEN.

The polyethylene was added in pellet form to the trichlorofluoromethane spin agent to form a spin solution of 11.4% polyethylene and 88.6% spin agent. The spin solution was prepared in a continuous mixing unit and delivered at a temperature of 181° C., and a pressure of about 13.3 MPa (1925 psi) through a heated transfer line to a pressure letdown chamber where the solution pressure dropped to about 6.3 MPa (914 psi). The solution discharged from the letdown chamber to a region maintained near atmospheric pressure and at about 42° C. through one of a linear array of sixty-four 1.43 mm (56.2 mil) spin orifices. The flow rate of the solution through each orifice was about 440 kg/hr (965 lbs/hr). The solution was flash-spun into plexifilamentary film-fibrils that were laid down onto a moving belt, consolidated to form a 2.92 meter (115 inch) wide sheet, and collected on a take-up roll as described above. The basis weight of the sheet was adjusted by by adjusting the speed of the belt (line speed) onto which the plexifilamentary material was laid down.

Next, the loosely consolidated sheet was thermally bonded. The consolidated sheet was thermally whole-surface bonded on each side using large drum (2.7 m diameter) bonders like the bonder described in U.S. Pat. No. 3,532,589 to David. The bonding drum was heated with steam, and the steam pressure and sheet speed were adjusted so as to obtain a sheet delamination strength of about 0.79 N/cm (0.45 lb/in). The sheet material of Comparative Examples 3-5 had a basis weight of about 74.2 g/m² (2.2 oz/yd²) and was bonded at a sheet speed of 130 m/min with a bonder steam pressure of 505 kPa (73.2 psi). The bonded sheets were corona treated on each side at a watt density in the range of 0.0210 to 0.0244 Watt-min/ft² in order to improve the adhesion of printing ink to the sheet. An antistatic treatment of a potassium butyl phosphate acid ester (ZELEC®-TY sold by DuPont) was applied as an aqueous solution and hot air dried to a weight of 45 milligrams/m².

The sheet of Comparative Example 3 was tested without further treatment. The bonded sheet of Comparative Example 4 was slit into 60 inch (1.52 m) wide rolls and then subjected to cold calendering. The bonded sheet of Comparative Example 5 was subjected to a hot calendering.

The cold calendering was done on a Beloit Super Calender with an 18 inch (45.7 cm) diameter steel roll that was maintained at 100° F. (37.80° C.). The steel roll had a surface roughness of about 20 microinches (0.51 microns). The sheet was wrapped on the steel roll with the smoother side of the sheet (side that faced the second bonding drum during bonding) facing the steel roll. The sheet was then passed through a calender nip formed between the steel roll and a hard cotton-filled backup roll having a 90 Shore D Hardness. The nip pressure was maintained at 580 lb/linear inch (1015.7 N/linear cm). The side of the calendered sheet that faced the steel roll was the side that was tested for smoothness and printed with a bar code for bar code for bar code scanability testing.

The hot calendering was done on a Thermal Calender Printer made by B.F. Perkins, a division of Roehlen Industries of Rochester, N.Y., with a 24 inch (61 cm) diameter steel roll that was maintained at 275° F. (135° C.). The steel roll had a surface roughness of about 8 microinches (0.20 microns). The sheet was wrapped on the steel roll with the smoother side of the sheet (side that faced the second bonding drum during bonding) facing the steel roll. The sheet was then passed through a calender nip formed between the steel roll and a resilient rubber backup roll having a 90 Shore A Hardness. The nip pressure was maintained at 500 lb/linear inch (875.6 N/linear cm). The side of the calendered sheet that faced the steel roll was the side that was tested for smoothness and printed with a bar code for bar code for bar code scanability testing.

The bonded sheets of Examples 3-5 were each printed with a bar code pattern as described in the Print Quality test method described above. The sheets were also tested for strength, elongation, opacity, and burst strength according to the test methods described above. The sheet properties for the uncalendered sheet (Comparative Example 3) are set forth in Table 7 below. The sheet properties for the cold calendered sheet (Comparative Example 4) are set forth in Table 8 below. The sheet properties for the hot calendered sheet (Comparative Example 5) are set forth in Table 9 below.

### EXAMPLES 7-12

In Examples 7-12, polyethylene plexifilamentary film fibril sheets were flash-spun and bonded as described in Comparative Examples 3-5 with the exception that the titanium dioxide of Example 1 was added to the polyethylene before the polyethylene was mixed with the solvent.

In Examples 7-9, a concentrate was formed by compounding Type RI 04 neutralized rutile titanium dioxide into the high density polyethylene of Comparative Examples 3-5 at 50% on-weight-polymer loading. This concentrate was obtained in pelletized form from Ampacet Europe S.A. of Messancy, Belgium under the name White HDPE MB 510710. The concentrate was subsequently tumble blended with the polyethylene of Comparative Examples 3-5 to form a mixture comprised of 96% polyethylene and 4% rutile titanium dioxide. This mixture was added to the spin agent of Comparative Examples 3-5 in the same proportions as Comparative Example 3-5 to form a spin solution. The spin solution was subsequently flash-spun under conditions identical to Comparative Examples 3-5, with the exception that the pressure in the letdown chamber was raised slightly to 6.4 MPa (928 psi), to produce a consolidated sheet.

In Examples 10-12, a concentrate was formed by compounding Type R104 neutralized rutile titanium dioxide into the high density polyethylene of Comparative Examples 3-5 at 50% on-weight-polymer loading. This concentrate was obtained in pelletized form from Ampacet Europe S.A. of Messancy, Belgium under the name White HDPE MB 510710. The concentrate was subsequently tumble blended with the polyethylene of Comparative Examples 3-5 to form a mixture comprised of 92% polyethylene and 8% rutile titanium dioxide. This mixture was added to the spin agent of Comparative Examples 3-5 in the same proportions as Comparative Example 3-5 to form a spin solution. The spin solution was subsequently flash-spun under conditions identical to Comparative Examples 3-5, with the exception that the pressure in the letdown chamber was raised slightly to 6.5 MPa (943 psi), to produce a consolidated sheet.

The consolidated sheet of Examples 7-12 was thermally bonded as described in Comparative Examples 3-5. The bonded sheet of Example 7 was tested without further treatment. The bonded sheet of Example 8 was slit into 60 inch (1.52 m) wide rolls and then subjected to cold calendering as described in Comparative Example 4. The bonded sheet of Example 9 was subjected to a hot calendering as described in Comparative Example 5. The sheet properties for the uncalendered sheet of Example 7 are set forth in Table 7 below. The sheet properties for the cold calendered sheet of Example 8 are set forth in Table 8 below. The sheet properties for the hot calendered sheet of Example 9 are set forth in Table 9 below.

The bonded sheet of Example 10 was tested without further treatment. The bonded sheet of Example 11 was slit into 60 inch (1.52 m) wide rolls and then subjected to cold calendering as described in Comparative Example 4. The bonded sheet of Example 12 was subjected to a hot calendering as described in Comparative Example 5. The sheet properties for the uncalendered sheet Example 10 are set forth in Table 7 below. The sheet properties for the cold calendered sheet of Example 11 are set forth in Table 8 below. The sheet properties for the ho t calendered sheet of Example 12 are set forth in Table 9 below.

TABLE 7
No Calendering

| | Comp. | | |
|---|---|---|---|
| | Ex. 3 | Ex. 7 | Ex. 10 |
| TiO₂ wt. % in polyethylene | 0 | 4 | 8 |
| Calendering Conditions | | | |
| Steel Roll Temp. (° C.) | — | — | — |
| Nip Pressure (N/linear cm) | — | — | — |
| Sheet Speed (m/min.) | — | — | — |
| Physical Properties | | | |
| Basis Weight (g/m²) | 78.0 | 74.6 | 66.1 |
| Thickness (microns) | 188 | 183 | 170 |
| Smoothness-Parker Tester (microns) | 5.82 | 5.84 | 5.31 |
| Gurley Hill Porosity (seconds) | 22.5 | 18.1 | 15 |
| Opacity (%) | 92.8 | 95.3 | 95.2 |
| Delamination (N/m) | 91 | 123 | 100 |
| Tensile Strength MD (N/cm) | 82.7 | 76.7 | 75.5 |
| Tensile Strength XD (N/cm) | 115.8 | 99.6 | 82.8 |
| Elongation MD (%) | 24.8 | 25.9 | 30.7 |
| Elongation XD (%) | 31.7 | 30.5 | 31.4 |
| Elmendorf Tear MD (N) | 3.9 | 3.2 | 2.0 |
| Elmendorf Tear XD (N) | 5.1 | 3.1 | 3.6 |
| Bar Code Readability | | | |
| Symbol Contrast (%) | 90/89 | 86/84 | 85/84 |
| Edge Contrast (%) | 41/41 | 50/53 | 53/52 |
| Modulation (%) | 45/46 | 58/63 | 62/64 |
| Decodability (%) | 60/57 | 62/63 | 60/61 |
| Defects (%) | 19/18 | 19/19 | 23/21 |
| Overall ANSI Grade | D/D | C/B | C/C |

TABLE 8
Cold Calendering

| | Comp. | | |
|---|---|---|---|
| | Ex. 4 | Ex. 8 | Ex. 11 |
| TiO₂ wt. % in polyethylene | 0 | 4 | 8 |
| Calendering Conditions | | | |
| Steel Roll Temp. (° C.) | 37.8 | 37.8 | 37.8 |
| Nip Pressure (N/linear cm) | 1015.7 | 1015.7 | 1015.7 |
| Sheet Speed (m/min.) | 152.4 | 152.4 | 152.4 |
| Physical Properties | | | |
| Basis Weight (g/m²) | 78.3 | 71.9 | 74.6 |
| Thickness (microns) | 132 | 127 | 119 |
| Smoothness-Parker Tester (microns) | 3.41 | 3.27 | 2.72 |
| Gurley Hill Porosity (seconds) | 82.3 | 47.3 | 31.3 |
| Opacity (%) | 92 | 93.7 | 94.8 |
| Delamination (N/m) | 100 | 123 | 81 |
| Tensile Strength MD (N/cm) | 90.5 | 101.6 | 83.5 |
| Tensile Strength XD (N/cm) | 104.4 | 87.9 | 88.4 |
| Elongation MD (%) | 26.9 | 28.2 | 27.3 |
| Elongation XD (%) | 29.1 | 32.2 | 29.1 |
| Elmendorf Tear MD (N) | 4.3 | 2.7 | 1.7 |
| Elmendorf Tear XD (N) | 4.1 | 3.3 | 3.5 |
| Bar Code Readability | | | |
| Symbol Contrast (%) | 80 | 83 | 82 |
| Edge Contrast (%) | 37 | 55 | 57 |
| Modulation (%) | 46 | 65 | 69 |
| Decodability (%) | 55 | 65 | 64 |
| Defects (%) | 20 | 20 | 21 |
| Overall ANSI Grade | D | B | C |

TABLE 9
Hot Calendering

| | Comp. | | |
|---|---|---|---|
| | Ex. 5 | Ex. 9 | Ex. 12 |
| TiO₂ wt. % in polyethylene | 0 | 4 | 8 |
| Calendering Conditions | | | |
| Steel Roll Temp. (° C.) | 875.6 | 875.6 | 875.6 |
| Nip Pressure (N/linear cm) | 114.3 | 114.3 | 114.3 |
| Sheet Speed (m/min.) | | | |
| Physical Properties | | | |
| Basis Weight (g/m²) | 78.0 | 71.2 | 66.1 |
| Thickness (microns) | 154 | 147 | 130 |
| Smoothness-Parker Tester (microns) | 3.22 | 3.3 | 3.38 |
| Gurley Hill Porosity (seconds) | 29.9 | 34.1 | 37.8 |
| Opacity (%) | 90.6 | 92.4 | 95.5 |
| Delamination (N/m) | 84 | 123 | 84 |
| Tensile Strength MD (N/cm) | 91.8 | 84.9 | 78.5 |
| Tensile Strength XD (N/cm) | 93.5 | 99.8 | 80.0 |
| Elongation MD (%) | 25.9 | 25.2 | 32.2 |
| Elongation XD (%) | 37.4 | 32.7 | 30.1 |
| Elmendorf Tear MD (N) | 3.9 | 2.8 | 3.3 |
| Elmendorf Tear XD (N) | 4.9 | 3.1 | 3.3 |
| Bar Code Readability | | | |
| Symbol Contrast (%) | 87 | 85 | 85 |
| Edge Contrast (%) | 43 | 55 | 58 |
| Modulation (%) | 49 | 64 | 68 |
| Decodability (%) | 59 | 61 | 62 |
| Defects (%) | 18 | 19 | 19 |
| Overall ANSI Grade | D | B | B |

### EXAMPLES 13-21

Plexifilamentary polyethylene film fibrils were flash-spun from a solution of polyethylene and trichlorofluoromethane spin agent. The polyethylene was high density polyethylene with a melt index of 2.3 g/10 minutes (@ 190° C. with a 5 kg weight), a melt flow ratio {MI (@ 190° C. with a 21.6 kg weight)/MI (@ 190° C. with a 5 kg weight)} of 11, and a density of 0.956 g/cc. The polyethylene was obtained from Hostalen GmbH of Frankfurt, Germany, under the tradename HOSTALEN.

The titanium dioxide of Example 1 was added to the polyethylene before the polyethylene was mixed with the spin agent. A concentrate was formed by compounding Type R104 neutralized rutile titanium dioxide into the high density polyethylene of Comparative Examples 3-5 at 50% on-weight-polymer loading. This concentrate was obtained in pelletized form from Ampacet Europe S.A. of Messancy, Belgium under the name White HDPE MB 510710. The concentrate was subsequently tumble blended with the polyethylene of Comparative Examples 3-5 to form a mixture comprised of 96% polyethylene and 4% rutile titanium dioxide. This mixture was added to the spin agent of Comparative Examples 3-5 in the same proportions as Comparative Example 3-5 to form a spin solution (11.4% polyethylene/titanium dioxide mixture and 88.6% spin agent). The spin solution was subsequently flash-spun under conditions identical to Comparative Examples 3-5, with the exception that the pressure in the letdown chamber was raised slightly to 6.4 MPa (928 psi), to produce a consolidated sheet. The basis weight of the sheet was adjusted by by adjusting the speed of the belt (line speed) onto which the plexifilamentary material was laid down.

Next, the loosely consolidated sheet was thermally bonded. The consolidated sheet was thermally whole-surface bonded on each side using large drum (2.7 m diameter) bonders like the bonder described in U.S. Pat. No. 3,532,589 to David. The bonding drum was heated with steam, and the steam pressure and sheet speed were adjusted so as to obtain a sheet delamination strength of about 0.79 N/cm (0.45 lb/in). The sheet material of Examples 13-21 were bonded under the following conditions:

| Examples | Target Basis Weight | Sheet Speed | Bonder Steam Pressure |
|---|---|---|---|
| 13, 14 | 54 g/m² | 169 m/min | 500 kPa |
| 15, 16 | 63 g/m² | 140 m/min | 500 kPa |
| 17, 18, 19 | 75 g/m² | 130 m/min | 505 kPa |
| 20, 21 | 102 g/m² | 110 m/min | 545 kPa |

The bonded sheets were corona treated on each side at a watt density in the range of 0.0210 to 0.0244 Watt-min/ft² in order to improve the adhesion of printing ink to the sheet. An antistatic treatment of a potassium butyl phosphate acid ester (ZELEC®-TY sold by DuPont) was applied as an aqueous solution and hot air dried to a weight of 45 milligrams/m².

The bonded sheet of Example 13, 15, 17, and 20 was tested without further treatment. The bonded sheet of Examples 14, 16, 18, and 21 was slit into 60 inch (1.52 m) wide rolls and then subjected to cold calendering as described in Comparative Example 4. The bonded sheet of Example 19 was subjected to a hot calendering as described in Comparative Example 5. The bonded sheets of Examples 13-21 were each printed with a bar code pattern as described in the Print Quality test method described above. The sheets were also tested for strength, elongation, opacity, and burst strength according to the test methods described above. The sheet properties are set forth in Table 10 below.

TABLE 10

| Example | 13 | 14 | 15 | 16 |
|---|---|---|---|---|
| Basis Weight (g/m²) | 53.2 | 53.6 | 63.1 | 62.7 |
| TiO₂ wt. % in the polyethylene | 4 | 4 | 4 | 4 |
| Line Speed (m/min) | 335 | 335 | 290 | 290 |
| Calendering Conditions | | | | |
| Calender Type | None | Cold | None | Cold |
| Steel Roll Temp. (° C.) | — | 37.8 | — | 37.8 |
| Nip Pressure (N/linear cm) | — | 1015.7 | — | 1015.7 |
| Line Speed (m/min.) | — | 152.4 | — | 152.4 |
| Physical Properties | | | | |
| Thickness (microns) | 138 | 116 | 145 | 117 |
| Smoothness-Parker Tester (microns) | 5.6 | 3.7 | 5.59 | 3.56 |
| Gurley Hill Porosity (seconds) | 8.0 | 17.0 | 11.9 | 15.4 |
| Opacity (%) | 93.1 | 90.4 | 93.9 | 93.5 |
| Delamination (N/m) | 92.8 | 80.6 | 82.3 | 91.1 |
| Tensile Strength MD (N/cm) | 56.0 | 54.6 | 67.6 | 74.8 |
| Tensile Strength XD (N/cm) | 60.2 | 60.1 | 82.5 | 80.6 |
| Elongation MD (%) | | 22.7 | | 28.8 |
| Elongation XD (%) | | 25.7 | | 29.4 |
| Elmendorf Tear MD (N) | 2.5 | 3.2 | 2.5 | 3.5 |
| Elmendorf Tear XD (N) | 3.3 | 3.4 | 3.2 | 3.4 |
| Bar Code Readability | | | | |
| Symbol Contrast (%) | 83 | 81 | 84 | 82 |
| Edge Contrast (%) | 44 | 51 | 44 | 52 |
| Modulation (%) | 53 | 62 | 52 | 63 |
| Decodability (%) | 60 | 60 | 54 | 64 |
| Defects (%) | 20 | 17 | 21 | 19 |
| Overall ANSI Grade | C | B | C | B |

| Example | 17 | 18 | 19 | 20 | 21 |
|---|---|---|---|---|---|
| Basis Weight (g/m²) | 71.5 | 72.9 | 69.6 | 97.6 | 98.3 |
| TiO₂ wt. % in the polyethylene | 4 | 4 | 4 | 4 | 4 |
| Line Speed (m/min.) | 258 | 258 | 258 | 190 | 190 |
| Calendering Conditions | | | | | |
| Calender Type | None | Cold | Hot | None | Cold |
| Steel Roll Temp. (° C.) | — | 37.8 | 135 | — | 37.8 |
| Nip Pressure (N/linear cm) | — | 1015.7 | 875.6 | — | 1015.7 |
| Sheet Speed (m/min.) | — | 152.4 | 114.3 | — | 152.4 |
| Physical Properties | | | | | |
| Thickness (microns) | 168 | 137 | 147 | 218 | 157 |
| Smoothness-Parker Tester | 5.57 | 3.82 | 3.3 | 6.27 | 4.28 |
| (microns) | | | | | |
| Gurley Hill Porosity (seconds) | 16.1 | 27.3 | 34.1 | 20.4 | 52 |
| Opacity (%) | 95.4 | 94.9 | 92.4 | 97.4 | 92.1 |
| Delamination (N/m) | 91.1 | 87.6 | 122.6 | 91.1 | 148.9 |
| Tensile Strength MD (N/cm) | 76.0 | 80.9 | 84.9 | 110.6 | 116.8 |
| Tensile Strength XD (N/cm) | 94.9 | 94.9 | 99.8 | 134.1 | 132.0 |
| Elongation MD (%) | | 26.7 | 25.2 | | 34.0 |
| Elongation XD (%) | | 33.2 | 32.7 | | 33.2 |
| Elmendorf Tear MD (N) | 2.6 | 4.1 | 2.8 | 3.1 | 3.7 |
| Elmendorf Tear XD (N) | 3.2 | 4.3 | 3.1 | 3.9 | 4.2 |
| Bar Code Readability | | | | | |
| Symbol Contrast (%) | 85 | 86 | 85 | 87 | 87 |
| Edge Contrast (%) | 47 | 56 | 55 | 45 | 55 |
| Modulation (%) | 54 | 64 | 64 | 51 | 63 |
| Decodability (%) | 59 | 65 | 61 | 51 | 64 |
| Defects (%) | 21 | 19 | 19 | 20 | 18 |
| Overall ANSI Grade | C | B | B | C | B |

### COMPARATIVE EXAMPLES 6 and 7

Plexifilamentary polyethylene film fibrils were flash-spun from a solution of polyethylene and trichlorofluoromethane spin agent. The polyethylene was high density polyethylene with a melt index of 2.3 g/10 minutes (@ 190° C. with a 5 kg weight), a melt flow ratio {MI (@ 190° C. with a 21.6 kg weight)/MI (@ 190° C. with a 5 kg weight)} of 11, and a density of 0.956 g/cc. The polyethylene was obtained from Hostalen GmbH of Frankfurt, Germany, under the tradename HOSTALEN.

The polyethylene was added in pellet form to the trichlorofluoromethane spin agent to form a spin solution of 11.4% polyethylene and 88.6% spin agent. The spin solution was prepared in a continuous mixing unit and delivered at a temperature of 181° C., and a pressure of about 13.3 MPa ( 1925 psi) through a heated transfer line to a pressure letdown chamber where the solution pressure dropped to about 6.3 MPa (914 psi). The solution discharged from the letdown chamber to a region maintained near atmospheric pressure and at about 42° C. through one of a linear array of sixty-four 1.43 mm (56.2 mil) spin orifices. The flow rate of the solution through each orifice was about 440 kg/hr (965 lbs/hr). The solution was flash-spun into plexifilamentary film-fibrils that were laid down onto a moving belt, consolidated to form a 2.92 meter (115 inch) wide sheet, and collected on a take-up roll as described above. The basis weight of the sheet was adjusted by adjusting the speed of the belt (line speed) onto which the plexifilamentary material was laid down.

Next, the loosely consolidated sheet was thermally bonded. The consolidated sheet was thermally whole-surface bonded on each side using large drum (2.7 m diameter) bonders like the bonder described in U.S. Pat. No. 3,532,589 to David. The bonding drum was heated with steam, and the steam pressure and sheet speed were adjusted so as to obtain a sheet delamination strength of about 0.8 to 1.0 N/cm (0.5 to 0.6 lb/in). The sheet material of Comparative Examples 6 had a basis weight of about 53.2 g/m² (1.57 oz/yd²) and was bonded at a sheet speed of 160 m/min with a bonder steam pressure of 530 kPa (76.8 psi) on the first bonding drum with the rougher side (the belt side from the spinning machine) next to the bonding drum and 470 kPa (68.2 psi) on the second bonding drum with the opposite (smooth) side next to the bonding drum. The sheet material of Comparative Examples 7 had a basis weight of about 65.9 g/m² (1.94 oz/yd²) and was bonded at a sheet speed of 140 m/min with a bonder steam pressure of 530/470 kPa (76.8/68.2 psi) rough side/smooth side. The bonded sheets of Comparitive Examples 6 and 7 did not receive a corona or antistatic treatment as sterile packaging regulators may not permit these treatments.

The bonded sheet of Comparative Example 6 was printed with a bar code pattern using an Aqua/Flex flexographic print press manufactured by Didde Corporation. Code 39 symbology bar codes were used. The print quality was measured according to ANSI X3.182-1990. The sheets in both Comparative Examples 6 and 7 were also tested for tear and tensile strength, burst strength, delamination strength and opacity. Average opacity and thin spot opacity were measured. The sheet properties are set forth in Table 11 below.

### EXAMPLES 22 and 23

In Examples 22 and 23, polyethylene plexifilamentary film fibril sheets were flash-spun and bonded as described in Comparative Examples 6 and 7 with the exception that the titanium dioxide of Example 1 was added to the polyethylene before the polyethylene was mixed with the solvent.

In Examples 22 and 23, a concentrate was formed by compounding Type R104 neutralized rutile titanium dioxide into the high density polyethylene of Comparative Examples 6 and 7 at 50% on-weight-polymer loading. This concentrate was obtained in pelletized form from Ampacet Europe S.A. of Messancy, Belgium under the name White HDPE MB 510710. The concentrate was subsequently tumble blended with the polyethylene of Comparative Examples 6 and 7 to form a mixture nominally comprised of 96% polyethylene and 4% rutile titanium dioxide (actually 96.4% and 3.6% for Example 22 and 96.1% and 3.9% for Example 23 as measured in the final sheet). This mixture was added to the spin agent of Comparative Examples 6 and 7 in the same proportions as Comparative Examples 6 and 7 to form a spin solution. The spin solution was subsequently flash-spun under conditions identical to Comparative Examples 6 and 7 ( with the exception that the pressure in the letdown chamber was raised slightly to 6.4 MPa (928 psi)) to produce a consolidated sheet.

The consolidated sheet of Examples 22 and 23 was thermally bonded as described in Comparative Examples 6 and 7. The bonded sheet of Example 22 was printed with a bar code pattern using an Aqua/Flex flexographic print press manufactured by Didde Corporation. Code 39 symbology bar codes were used. The print quality was measured according to ANSI X3.182-1990. The sheets in both Examples 22 and 23 were also tested for tear and tensile strength, burst strength, delamination strength and opacity. Average opacity and thin spot opacity were measured. The sheet properties are set forth in Table 11 below.

TABLE 11

| | Comp. | | Comp. | |
|---|---|---|---|---|
| | Ex. 6 | Ex. 22 | Ex. 7 | Ex. 23 |
| TiO₂ wt. % in polyethylene | 0 | 3.6 | 0 | 3.9 |
| Bonding Conditions | | | | |
| Bonder speed (m/min) | 160 | 160 | 140 | 140 |
| Bonder steam pressure - | 530 | 530 | 530 | 530 |
| rough side (kPa) | | | | |
| Bonder steam pressure - | 470 | 470 | 470 | 470 |
| smooth side (kPa) | | | | |
| Physical Properties | | | | |
| Basis Weight (g/m²) | 53.2 | 54.6 | 65.9 | 62.8 |
| Gurley Hill Porosity (seconds) | 14.3 | 6.9 | 19.1 | 13.5 |
| Opacity (%) | 89.9 | 92.3 | 90.8 | 94.3 |
| Thin spot opacity (%) | 75.3 | 83.7 | 83.1 | 91.0 |
| Delamination (N/m) | 82 | 89 | 93 | 96 |
| Tensile Strength MD (N/cm) | 59.7 | 54.6 | 71.3 | 75.1 |
| Tensile Strength XD (N/cm) | 64.3 | 67.6 | 82.7 | 83.9 |
| Elmendorf Tear MD (N) | 2.8 | 2.2 | 3.5 | 2.6 |
| Elmendorf Tear XD (N) | 3.8 | 3.2 | 4.5 | 3.6 |
| Microbial Barrier (LRV) | 4.1 | 3.8 | 5.0 | 4.9 |
| Bar Code Readability | | | | |
| Symbol Contrast (%) | 77 | 73 | — | — |
| Edge Contrast (%) | 35 | 41 | — | — |
| Modulation (%) | 44 | 56 | — | — |
| Decodability (%) | 58 | 64 | — | — |
| Defects (%) | 24 | 24 | — | — |
| Overall ANSI Grade | D | C | — | — |

### EXAMPLE 24

In Example 24, plexifilamentary polyethylene film fibrils were flash-spun from a solution of polyethylene and pentane spin agent which contained the same TiO₂ as Examples 22 and 23. The polyethylene was high density polyethylene with a melt index of 2.35 g/10 minutes (@ 190° C. with a 5 kg weight), a melt flow ratio {MI (@ 190° C. with a 21.6 kg weight)/MI (@ 190° C. with a 5 kg weight)} of 10.4, and a density of 0.956 g/cc. The polyethylene was obtained from Hostalen GmbH of Frankfurt, Germany, under the tradename HOSTALEN.

The polyethylene and TiO₂ were blended as in Examples 22 and 23 and added to a spin agent consisting of 71% normal pentane and 29% cyclopentane to form a spin solution of 14.5 weight percent polyethylene, 3.5 weight percent TiO₂ and 82 weight percent spin agent. Additional additives consisted of 1000 parts per million Fiberstab 210 stabilizer from CIBA-GEIGY and 300 parts per million calcium stearate. The spin solution was prepared in a continuous mixing unit and delivered at a temperature of 178° C., and a pressure of about 9.4 MPa through a heated transfer line to a pressure letdown chamber where the solution pressure dropped to about 6.4 MPa. The solution discharged from the letdown chamber to a region maintained near atmospheric pressure and at about 54° C. through one of an array of one hundred twenty eight 0.87 mm (34.3 mil) spin orifices. The flow rate of the solution through each orifice was about 22.0 kg/hr (48.5 lbs/hr). The solution was flash-spun into plexifilamentary film-fibrils that were laid down onto a moving belt, consolidated to form a 3.34 meter wide sheet, and collected on a take-up roll as described above. The basis weight of the sheet was adjusted by adjusting the speed of the belt (line speed) onto which the plexifilamentary material was laid down.

Next, the loosely consolidated sheet was thermally bonded. The consolidated sheet was thermally whole-surface bonded on each side using large drum (2.7 m diameter) bonders like the bonder described in U.S. Pat. No. 3,532,589 to David. The bonding drum was heated with steam, and the steam pressure and sheet speed were adjusted so as to obtain a sheet delamination strength of about 0.8 to 1.0 N/cm (0.5 to 0.6 lb/in). The sheet material of Example 24 had a basis weight of about 56.6 g/m² and was bonded at a sheet speed of 130 m/min with a bonder steam pressure of 500 kPa on the first bonding drum with the rougher side (the belt side from the spinning machine) next to the bonding drum and 360 kPa on the second bonding drum with the opposite (smooth) side next to the bonding drum. The bonded sheet properties are given in Table 12.

TABLE 12

| | Ex. 24 |
|---|---|
| TiO₂ wt. % in polyethylene | 3.5 |
| Bonding Conditions | |
| Bonder speed (m/min) | 130 |
| Bonder steam pressure- | 500 |
| rough side (kPa) | |
| Bonder steam pressure- | 360 |
| smooth side (kPa) | |
| Physical Properties | |
| Basis Weight (g/m²) | 56.6 |
| Gurley Hill Porosity (seconds) | 29.0 |
| Opacity (%) | 94.8 |
| Delamination (N/m) | 98 |
| Tensile Strength MD (N/cm) | 56.2 |
| Tensile Strength XD (N/cm) | 57.4 |
| Elmendorf Tear MD (N) | 2.5 |
| Elmendorf Tear XD (N) | 3.7 |
| Microbial Barrier (LRV) | 3.0 |

### COMPARATIVE EXAMPLE 8

The spunbonded sheet of plexifilamentary polyethylene film fibrils of Comparative Example 6 was sealed to a 4 mil (102 microns) thick film with an adhesive coating sold by Rexam Corporation, Madison Wis. under the product code 141U. The film consisted of a SURLYN® ionomer film coated on both sides with an ethylene vinyl acetate (“EVAc”) film that was about 1 mil thick, wherein the EVAc film coating on one side was slightly thicker than on the other side. SURLYN® is a registered trademark of DuPont. The EVAc coating acts as an adhesive when heated. The seals were prepared by placing the spunbonded sheet of Comparative Example 6 over the EVAc/SURLYN®/EVAc film with the slightly thicker EVAc-coated side facing the spunbonded sheet. The spunbonded sheet and film were together fed into a bar sealing machine having a 1 inch wide by 9 inch long sealing bar which was used to form a seal between the spunbonded sheet and the film. The bar sealing machine was a “12-ALS” Bar Sealer manufactured by Sentinel Corporation (now known as Sencorp) of Hyannis Port, Mass. The bar was electrically heated and could be raised and lowered by air pressure. The heated bar had a TEFLON® coating to keep the bar from sticking to items being sealed. The temperature of the bar was measured using a hand-held, calibrated band thermocouple on the surface of the bar.

The sealing bar was heated to and maintained at one of the following temperatures: 260° F., 265° F., 270° F., 275° F. These temperatures were measured over the central portion of the bar surface, with the bar being up to 10° F. cooler at the edges of the bar. At each of the four bar temperatures, the bar was lowered against the exposed surface of the spunbonded sheet of a spunbond sheet/film sample, and then pressed down with a pressure of about 40 psi on the bar for a period of 3, 5 or 7 seconds (“the dwell time”). For each of the four bar temperatures, six to nine seals were generated at each of the three dwell times. The seals were removed from the bar sealing machine and inspected for thin spots.

Light transmission through each seal was measured on any thin spots found in the central portion of the seal. The transmitted light was measured using a Macbeth densitometer and is expressed as a percent of the incident light. Thin spots with a percent transmission greater than about 25 to 30 percent are objectionable because they appear transparent. The number of thin-spot, light transmission measurements taken on each seal was dependent on the number of thin spots identified on the seal. At each temperature/dwell time combination, the total number of thin-spot measurements on all of the seals generated for that temperature/dwell time combination ranged between 6 and 18. All of the thin-spot, light transmission measurements for each temperature/dwell time combination were averaged together and are reported in Table 13 below.

### EXAMPLE 25

The spunbonded sheet of plexifilamentary polyethylene film fibrils of Example 22 was sealed to a 4 mil (102 microns) thick film sold by Rexam Corporation, Madison Wis. under the product code 141U. The film consisted of SURLYN® ionomer film coated on both sides with a film of ethylene vinyl acetate (“EVAc”) that was about 1 mil thick, wherein the EVAc film coating on one side was slightly thicker than on the other side. The EVAc film acts as an adhesive when heated. The seals were prepared by placing the spunbonded sheet of Example 22 over the EVAc/SURLYN®/EVAc film with the slightly thicker EVAc-coated side facing the spunbonded sheet. The spunbonded sheet and film were together fed into a bar sealing machine having a 1 inch wide by 9 inch long sealing bar which was used to form a seal between the spunbonded sheet and the film. The bar sealing machine was a “12-ALS” Bar Sealer manufactured by Sentinel Corporation (now known as Sencorp) of Hyannis Port, Mass. The bar was electrically heated and could be raised and lowered by air pressure. The heated bar had a TEFLON® coating to keep the bar from sticking to items being sealed. The temperature of the bar was measured using a hand-held, calibrated band thermocouple on the surface of the bar.

The sealing bar was heated to and maintained at one of the following temperatures: 260° F., 265° F., 270° F., 275° F. These temperatures were measured over the central portion of the bar surface, with the bar being up to 10° F. cooler at the edges of the bar. At each of the four bar temperatures, the bar was lowered against the exposed surface of the spunbonded sheet of a spunbond sheet/film sample, and then pressed down with a pressure of about 40 psi on the bar for a period of 3, 5 or 7 seconds (“the dwell time”). For each of the four bar temperatures, six to nine seals were generated at each of the three dwell times. The seals were removed from the bar sealing machine and inspected for thin spots.

Light transmission through each seal was measured on any thin spots found in the central portion of the seal. The transmitted light was measured using a Macbeth densitometer and is expressed as a percent of the incident light. Thin spots with a percent transmission greater than about 25 to 30 percent are objectionable because they appear transparent. The number of thin-spot, light transmission measurements taken on each seal was dependent on the number of thin spots identified on the seal. At each temperature/dwell time combination, the total number of thin-spot measurements on all of the seals generated for that temperature/dwell time combination ranged between 3 and 18. All of the thin-spot, light transmission measurements for each temperature/dwell time combination were averaged together and are reported in Table 13 below.

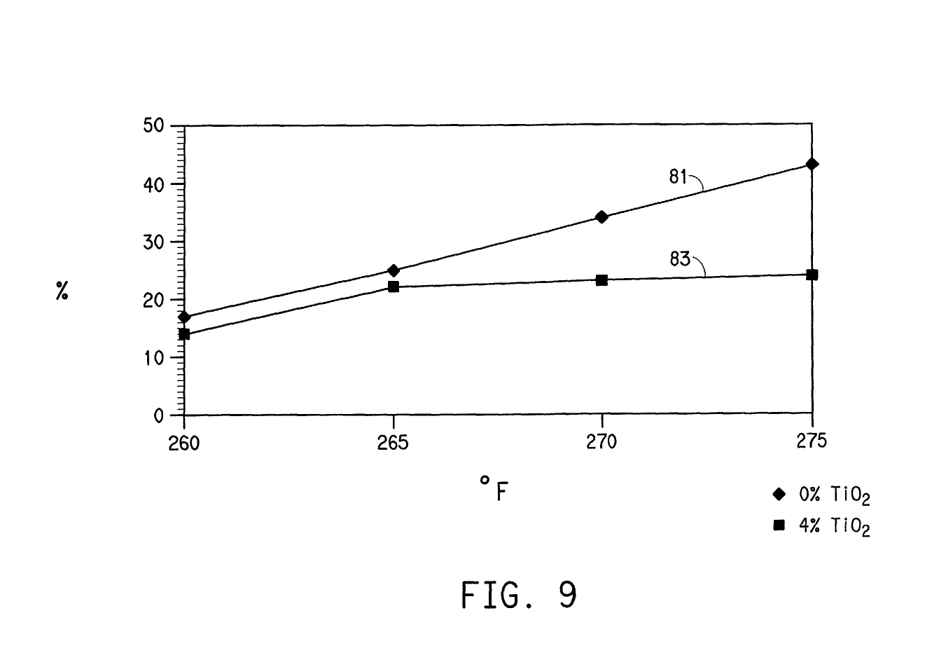

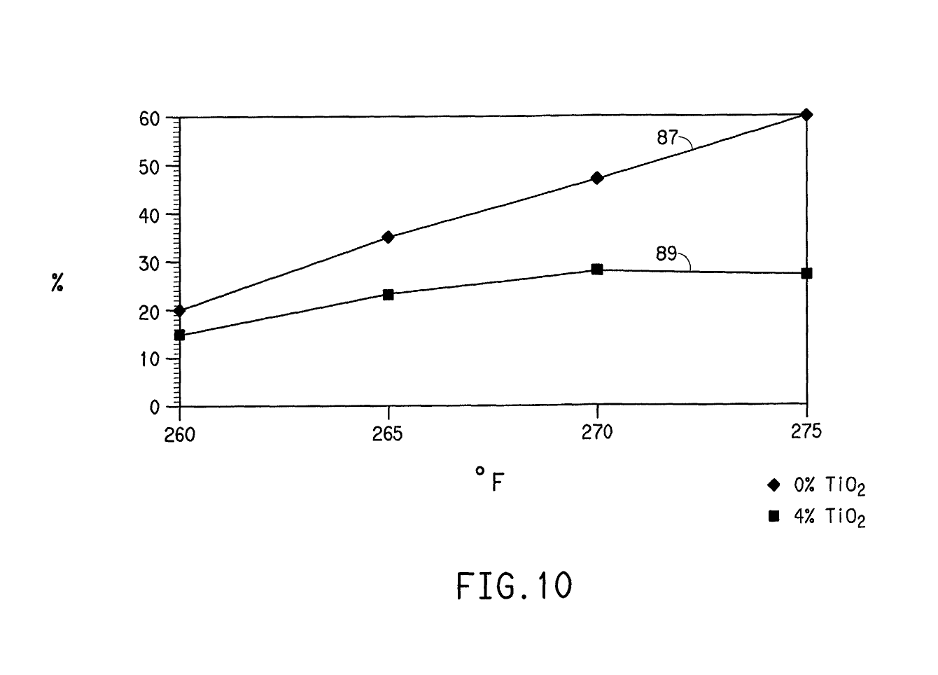

FIG. 9 is a graph of the light transmission measurements at various bar temperatures for the 5 second dwell time. The 0% TiO₂ sample of Comparative Example 8 (curve 81) is compared against the 3.6% TiO₂ sample of Example 25 (curve 83). FIG. 10 is a graph of the light transmission measurements at various bar temperatures for the 7 second dwell time. The 0% TiO₂ sample of Comparative Example 8 (curve 87) is compared against the 3.6% TiO₂ sample of Example 25 (curve 89)

TABLE 13

| | | Comp. Ex. 8 | Ex. 25 |
|---|---|---|---|
| | | (0% TiO₂) | (3.6% TiO₂) |
| Bar Temperature | Dwell Time | Light | Light |
| (° F.) | (seconds) | Transmission (%) | Transmission (%) |
| 260 | 3 | 21 | 14 |
| 260 | 5 | 17 | 14 |
| 260 | 7 | 20 | 15 |
| 265 | 3 | 24 | 12 |
| 265 | 5 | 25 | 22 |
| 265 | 7 | 35 | 23 |
| 270 | 3 | 28 | 16 |
| 270 | 5 | 34 | 23 |
| 270 | 7 | 47 | 28 |
| 275 | 3 | 31 | 22 |
| 275 | 5 | 43 | 24 |
| 275 | 7 | 60 | 27 |

### COMPARATIVE EXAMPLE 9

Comparative Example 9 illustrates a form-fill-seal package made using the bonded sheet of Comparative Example 6 which does not contain TiO₂. A 141U Rexam film as described in Comparative Example 8 was shaped in a Multivac 5200 form-fill-seal machine. The film was formed into its desired shape on the form-fill-seal machine at 200 kPa forming pressure, a 115° C. forming (draw) temperature with a 0.2 to 1 draw ratio. The bonded plexifilamentary sheet of Comparative Example 6 was sealed to the formed Rexam 141U film in the form-fill-seal machine at 135° C., a pressure of 110 kPa and a dwell time of 3 seconds to produce a formed package. The package appeared visually non-uniform as a whole with very obvious thin spots in the bonded plexifilanentary sheet. The sealed areas had many transparent portions.

### EXAMPLE 26

Example 26 illustrates form-fill-seal package made using the bonded sheet of Example 22 which contains 3.6 percent TiO₂. A 141U Rexam film as described in Example 25 was shaped in a Multivac 5200 form-fill-seal machine. The film was formed into its desired shape on the form-fill-seal machine at 200 kPa forming pressure, a 115° C. forming (draw) temperature with a 0.2 to 1 draw ratio. For Example 26, the bonded plexifilamentary sheet of Example 22 containing 3.6% TiO₂ was sealed to the formed Rexam 141U film in the form-fill-seal machine at 135° C., a pressure of 110 kPa and a dwell time of 3 seconds. The package had a pleasing uniform appearance in which the thin spots were not obvious. The sealed areas did not show objectionable transparent portions.

Although particular embodiments of the present invention have been described in the foregoing description, it will be understood by those skilled in the art that the invention is capable of numerous modifications, substitutions and rearrangements without departing from the spirit or essential attributes of the invention. Reference should be made to the appended claims, rather than to the foregoing specification, as indicating the scope of the invention.

What is claimed is:

1. A gas permeable package comprised of a bonded, gas permeable, fibrous sheet material, said fibrous sheet material consisting of continuous lengths of bonded plexifilamentary fibril strands of a polyolefin polymer and a pigment wherein the polyolefin comprises at least 90% by weight of the fibril strands, the pigment comprises between 0.05% and 10% by weight of the fibril strands.

2. The gas permeable package of claim 1 wherein the fibrous sheet material has
a basis weight of less than 85 g/m²,
a delamination strength of at least 60 N/m, and
an opacity of at least 90% if the sheet has a delamination strength less than 120 N/m, an opacity of at least 85% if the sheet has a delamination strength between 120 N/m and 150 N/m, and an opacity of at least 80% if the sheet has a delamination strength greater than 150 N/m.

3. The gas permeable package of claim 1 wherein said polyolefin polymer is selected from the group of polyethylene, polypropylene, and copolymers comprised primarily of ethylene and propylene units.

4. The gas permeable package of claim 3 wherein said polyolefin is polyethylene.

5. The gas permeable package of claim 1 wherein at least 85% of said pigment is titanium dioxide.

6. The gas permeable package of claim 5 wherein said titanium dioxide consists essentially of particles of rutile titanium dioxide having an average particle size of less than 0.75 microns.

7. The gas permeable package of claim 6 wherein the titanium dioxide has a surface treatment of about 0.1 to about 5% by weight, based on the weight of the titanium dioxide, of at least one organosilicon compound having the formula: RxSi(R′)4-x wherein
R is a nonhydrolyzable aliphatic, cycloaliphatic or aromatic group having 8-20 carbon atoms;
R′ is a hydrolyzable group selected from alkoxy, halogen, acetoxy or hydroxy or mixtures thereof; and
x=1 to 3.

8. The gas permeable package of claim 5 wherein said fibrous sheet has a bar code readability, according to ANSI Standard X3.182-1990, of at least 2.0.

9. The gas permeable package of claim 8 wherein said fibrous sheet material has an opacity of at least 92%.

10. The gas permeable package of claim 5 wherein titanium dioxide comprises between 2% and 6% by weight of the fibril strands.

11. The gas permeable package of claim 2 wherein at least 90% of said pigment is color pigment having a chroma value greater than 0.

12. The gas permeable package of claim 11 wherein the color pigment comprises between 0.05% and 5% by weight of the fibril strands, and the sheet has an opacity of at least 90%.

13. The gas permeable package of claim 2 wherein the fibrous sheet has a delamination strength of at least 70 N/m.

14. The gas permeable package of claim 2 wherein the fibrous sheet has a Gurley Hill Porosity, measured according to TAPPI T-460 OM-88, of less than 60 seconds.

15. The gas permeable package of claim 2 wherein the fibrous sheet has a spore log reduction value, measured according to ASTM F 1608-95, of at least 2.5.

16. The gas permeable package of claim 2 wherein the package is further comprised of a gas impermeable substrate bonded to said gas permeable, fibrous sheet material, said gas impermeable substrate comprised of a material selected from the group of gas impermeable films, moldable films, and rigid substrates.

17. The gas permeable package of claim 16 further comprising a thermoplastic adhesive between said gas permeable, fibrous sheet material and said gas impermeable substrate.

18. The gas permeable package of claim 17 wherein the fibrous sheet has a Gurley Hill Porosity, measured according to TAPPI T-460 OM-88, of less than 60 seconds, and a spore log reduction value, measured according to ASTM F 1608-95, of at least 2.5.
